(19) United States
(12) Patent Application Publication
(10) Pub. No.: US 2014/0036999 A1
(43) Pub. Date: Feb. 6, 2014

(54) FRAME PRIORITIZATION BASED ON PREDICTION INFORMATION

(71) Applicant: VID SCALE INC., Wilmington, DE (US)

(72) Inventors: Eun Ryu, San Diego, CA (US); Yan Ye, San Diego, CA (US); Yuwen He, San Diego, CA (US); Yong He, San Diego, CA (US)

(21) Appl. No.: 13/931,362

(22) Filed: Jun. 28, 2013

Related U.S. Application Data
(60) Provisional application No. 61/666,708, filed on Jun. 29, 2012.
(60) Provisional application No. 61/810,563, filed on Apr. 10, 2013.

(51) Int. Cl. H04N 7/32

(52) U.S. Cl. CPC H04N 19/00569
USPC 375/240.12

(57) ABSTRACT

Priority information may be used to distinguish between different types of video data, such as different video packets or video frames. The different types of video data may be included in the same temporal level and/or different temporal levels in a hierarchical structure. A different priority level may be determined for different types of video data at the encoder and may be indicated to other processing modules at the encoder, or to the decoder, or other network entities such as a router or a gateway. The priority level may be indicated in a header of a video packet or signaling protocol. The priority level may be determined explicitly or implicitly. The priority level may be indicated relative to another priority or using a priority identifier that indicates the priority level.

### CROSS-REFERENCE TO RELATED APPLICATIONS

This application claims the benefit of U.S. Provisional Patent Application No. 61/666,708, filed on Jun. 29, 2012, and U.S. Provisional Patent Application No. 61/810,563, filed on Apr. 10, 2013, the contents of which are incorporated by reference herein in their entirety.

### BACKGROUND

Various video formats, such as High Efficiency Video Coding (HEVC), generally include features for providing enhanced video quality. These video formats may provide enhanced video quality by encoding, decoding, and/or transmitting video packets differently based on their level of importance. More important video packets may be handled differently to mitigate loss and provide a greater quality of experience (QoE) at a user device. Current video formats and/or protocols may improperly determine the importance of different video packets and may not provide enough information for encoders, decoders, and/or the various processing layers therein to accurately distinguish the importance of different video packets for providing an optimum QoE.

### SUMMARY

Priority information may be used by an encoder, a decoder, or other network entities, such as a router or a gateway, to distinguish between different types of video data. The different types of video data may include video packets, video frames, or the like. The different types of video data may be included in temporal levels in a hierarchical structure, such as a hierarchical-B structure. The priority information may be used to distinguish between different types of video data having the same temporal level in the hierarchical structure. The priority information may also be used to distinguish between different types of video data having different temporal levels. A different priority level may be determined for different types of video data at the encoder and may be indicated to other processing layers at the encoder, the decoder, or other network entities, such as a router or a gateway.

The priority level may be based on an effect on the video information being processed. The priority level may be based on a number of video frames that reference the video frame. The priority level may be indicated in a header of a video packet or a signaling protocol. If the priority level is indicated in a header, the header may be a Network Abstraction Layer (NAL) header of a NAL unit. If the priority level is indicated in a signaling protocol, the signaling protocol may be a supplemental enhancement information (SEI) message or an MPEG media transport (MMT) protocol.

The priority level may be determined explicitly or implicitly. The priority level may be determined explicitly by counting a number of referenced macro blocks (MBs) or coding units (CUs) in a video frame. The priority level may be determined implicitly based on a number of times a video frame is referenced in a reference picture set (RPS) or a reference picture list (RPL).

The priority level may be indicated relative to another priority or using a priority identifier that indicates the priority level. The relative level of priority may be indicated as compared to the priority level of another video frame. The priority level for the video frame may be indicated using a one-bit index or a plurality of bits that indicates a different level of priority using a different bit sequence.

### BRIEF DESCRIPTION OF THE DRAWINGS

A more detailed understanding may be had from the following description, given by way of example in conjunction with the accompanying drawings.

FIG. 1A is a system diagram of an example communications system in which one or more disclosed embodiments may be implemented.

FIG. 1B is a system diagram of an example wireless transmit/receive unit (WTRU) that may be used within the communications system illustrated in FIG. 1A.

FIG. 1C is a system diagram of an example radio access network and an example core network that may be used within the communications system illustrated in FIG. 1A.

FIG. 1D is a system diagram of another example radio access network and an example core network that may be used within the communications system illustrated in FIG. 1A.

FIG. 1E is a system diagram of another example radio access network and an example core network that may be used within the communications system illustrated in FIG. 1A.

FIGS. 2A-2D are diagrams that illustrate different types of frame prioritization based on frame characteristics.

FIG. 3 is a diagram that illustrates example quality of service (QoS) handling techniques with frame priority.

FIGS. 4A and 4B are diagrams that illustrated example frame prioritization techniques.

FIG. 5 is a diagram of an example video streaming architecture.

FIG. 6 is a diagram that depicts an example for performing video frame prioritization with different temporal levels.

FIG. 7 is a diagram that depicts an example for performing frame referencing.

FIG. 8 is a diagram showing that depicts an example for performing error concealment.

FIGS. 9A-9F are graphs that show a comparison of performance between frames dropped at different positions in a video stream and that are in the same temporal level.

FIG. 10 is a diagram that depicts an example encoder for performing explicit frame prioritization.

FIG. 11 is a flow diagram of an example method for performing implicit prioritization.

FIG. 12 is a flow diagram of an example method for performing explicit prioritization.

FIG. 13A is a graph that shows an average data loss recovery as a result of Raptor forward error correction (FEC) codes in various Packet Loss Rate (PLR) conditions.

FIGS. 13B-13D are graphs that show an average peak signal-to-noise ratio (PSNR) of unequal error protection (UEP) tests with various frame sequences.

FIGS. 14A and 14B are diagrams that depict example headers that may be used to provide priority information.

FIGS. 15A-15D are diagrams that depict example headers that may be used to provide priority information.

FIG. 16 is a diagram that depicts an example real-time transport protocol (RTP) payload format for aggregation packets.

### DETAILED DESCRIPTION

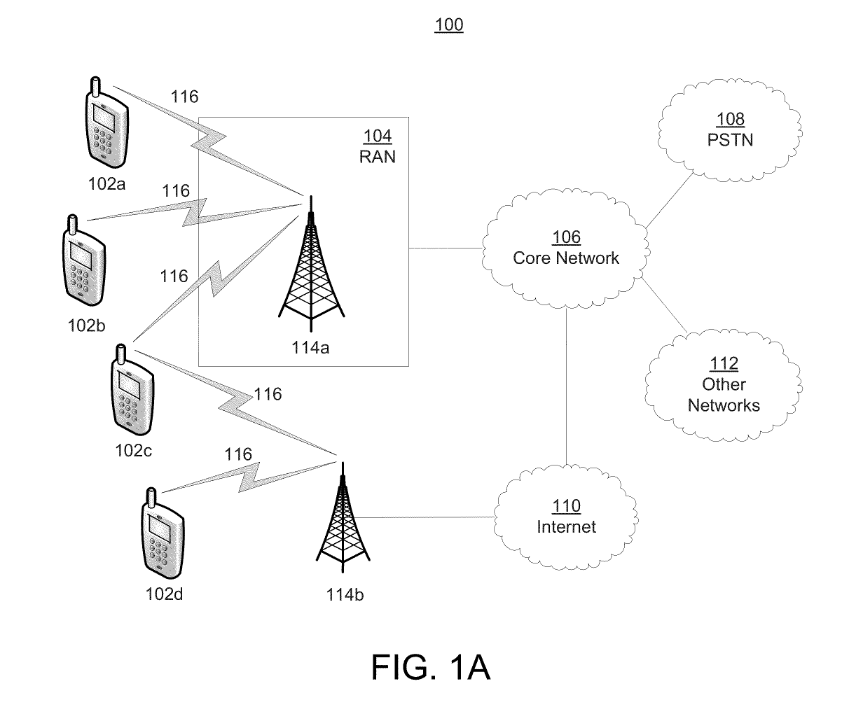

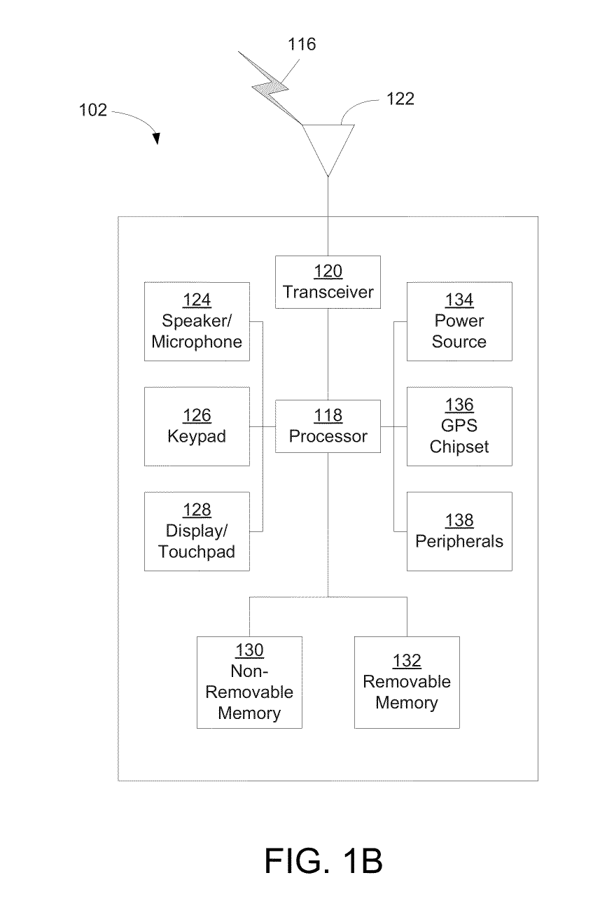

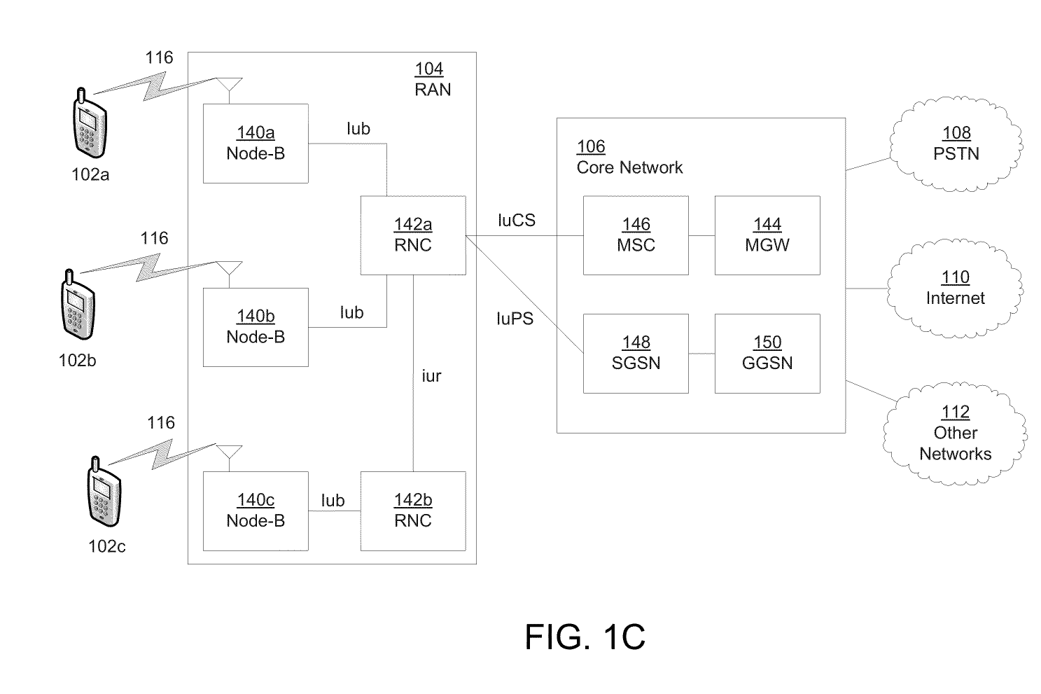

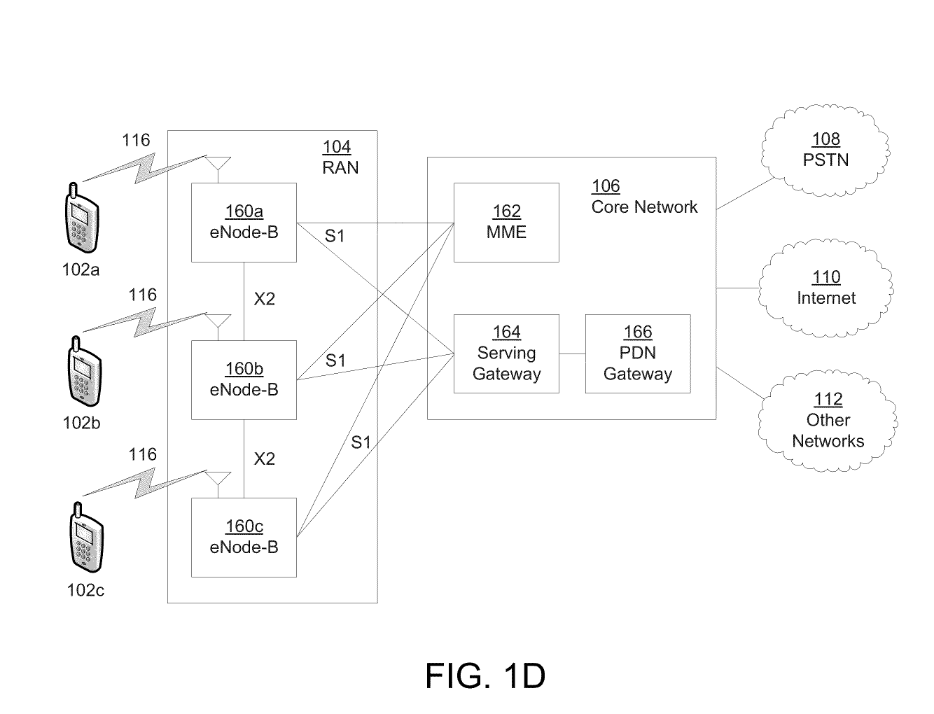

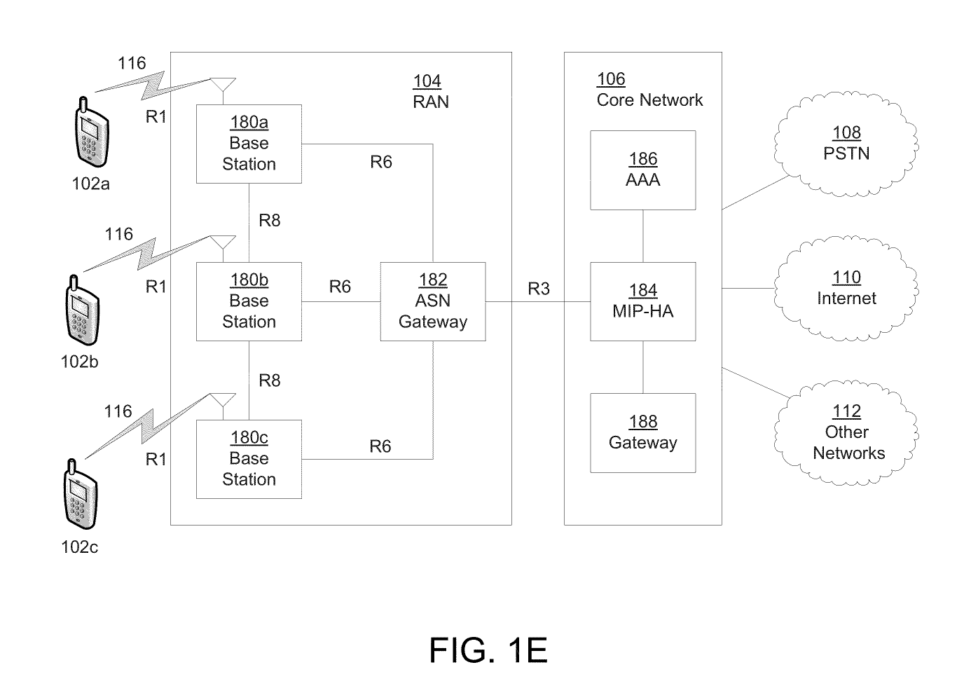

FIG. 1A is a diagram of an example communications system 100. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though any number of WTRUs, base stations, networks, and/or network elements may be implemented. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and/or the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers (e.g., one for each sector of the cell). The base station 114a may employ multiple-input multiple output (MIMO) technology and may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

The communications system 100 may be a multiple access system and may employ one or more channel access schemes, such as CDMA, TDMA, FDMA, OFDMA, SC-FDMA, and/or the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (e.g., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and/or the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and/or the like. The base station 114b and the WTRUs 102c, 102d may implement a radio technology such as IEEE 802.11 to establish a wireless local area network (WLAN). The base station 114b and the WTRUs 102c, 102d may implement a radio technology such as IEEE 802.15 to establish a wireless personal area network (WPAN). The base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not access the Internet 110 via the core network 106.

The RAN 104 may be in communication with the core network 106, which may be any type of network configured to provide voice, data (e.g., video), applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and other peripherals 138. The WTRU 102 may include any sub-combination of the foregoing elements. The components, functions, and/or features described with respect to the WTRU 102 may also be similarly implemented in a base station or other network entity, such as a router or gateway.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing (e.g., encoding/decoding), power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, the processor 118 and the transceiver 120 may be integrated together in an electronic package or chip.

The transmit/receive element 122 may be configured to transmit signals to, or receive signals from, a base station (e.g., the base station 114a) over the air interface 116. For example, the transmit/receive element 122 may be an antenna configured to transmit and/or receive RF signals. The transmit/receive element 122 may be an emitter/detector configured to transmit and/or receive IR, UV, or visible light signals, for example. The transmit/receive element 122 may be configured to transmit and receive both RF and light signals. The transmit/receive element 122 may be configured to transmit and/or receive any combination of wireless signals.

Although the transmit/receive element 122 is depicted in FIG. 1B as a single element, the WTRU 102 may include any number of transmit/receive elements 122. The WTRU 102 may employ MIMO technology. Thus, the WTRU 102 may include two or more transmit/receive elements 122 (e.g., multiple antennas) for transmitting and/or receiving wireless signals over the air interface 116.

The transceiver 120 may be configured to modulate the signals that are to be transmitted by the transmit/receive element 122 and to demodulate the signals that are received by the transmit/receive element 122. The WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. The processor 118 may access information from, and store data in, any type of suitable memory, such as the non-removable memory 130 and/or the removable memory 132. The non-removable memory 130 may include random-access memory (RAM), read-only memory (ROM), a hard disk, and/or any other type of memory storage device. The removable memory 132 may include a subscriber identity module (SIM) card, a memory stick, a secure digital (SD) memory card, and/or the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and/or the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. The WTRU 102 may acquire location information by way of any suitable location-determination method.

The processor 118 may be further coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and/or the like.

FIG. 1C is an example system diagram of the RAN 104 and the core network 106. As noted above, the RAN 104 may employ a UTRA radio technology to communicate with the WTRUs 102a, 102b, 102c over the air interface 116. The RAN 104 may be in communication with the core network 106. As shown in FIG. 1C, the RAN 104 may include Node-Bs 140a, 140b, 140c, which may each include one or more transceivers for communicating with the WTRUs 102a, 102b, 102c over the air interface 116. The Node-Bs 140a, 140b, 140c may each be associated with a particular cell (not shown) within the RAN 104. The RAN 104 may also include RNCs 142a, 142b. The RAN 104 may include any number of Node-Bs and RNCs.

As shown in FIG. 1C, the Node-Bs 140a, 140b may be in communication with the RNC 142a. Additionally, the Node-B 140c may be in communication with the RNC 142b. The Node-Bs 140a, 140b, 140c may communicate with the respective RNCs 142a, 142b via an Iub interface. The RNCs 142a, 142b may be in communication with one another via an Iur interface. Each of the RNCs 142a, 142b may be configured to control the respective Node-Bs 140a, 140b, 140c to which it is connected. In addition, each of the RNCs 142a, 142b may be configured to carry out or support other functionality, such as outer loop power control, load control, admission control, packet scheduling, handover control, macrodiversity, security functions, data encryption, and/or the like.

The core network 106 shown in FIG. 1C may include a media gateway (MGW) 144, a mobile switching center (MSC) 146, a serving GPRS support node (SGSN) 148, and/or a gateway GPRS support node (GGSN) 150. While each of the foregoing elements are depicted as part of the core network 106, any one of these elements may be owned and/or operated by an entity other than the core network operator.

The RNC 142a in the RAN 104 may be connected to the MSC 146 in the core network 106 via an IuCS interface. The MSC 146 may be connected to the MGW 144. The MSC 146 and the MGW 144 may provide the WTRUs 102a, 102b, 102c with access to circuit-switched networks, such as the PSTN 108, to facilitate communications between the WTRUs 102a, 102b, 102c and traditional land-line communications devices.

The RNC 142a in the RAN 104 may also be connected to the SGSN 148 in the core network 106 via an IuPS interface. The SGSN 148 may be connected to the GGSN 150. The SGSN 148 and the GGSN 150 may provide the WTRUs 102a, 102b, 102c with access to packet-switched networks, such as the Internet 110, to facilitate communications between and the WTRUs 102a, 102b, 102c and IP-enabled devices.

As noted above, the core network 106 may also be connected to the networks 112, which may include other wired or wireless networks that are owned and/or operated by other service providers.

FIG. 1D is an example system diagram of the RAN 104 and the core network 106. The RAN 104 may employ an E-UTRA radio technology to communicate with the WTRUs 102a, 102b, 102c over the air interface 116. The RAN 104 may be in communication with the core network 106.

The RAN 104 may include eNode-Bs 160a, 160b, 160c, though the RAN 104 may include any number of eNode-Bs. The eNode-Bs 160a, 160b, 160c may each include one or more transceivers for communicating with the WTRUs 102a, 102b, 102c over the air interface 116. The eNode-Bs 160a, 160b, 160c may implement MIMO technology. The eNode-Bs 160a, 160b, 160c may each use multiple antennas to transmit wireless signals to, and/or receive wireless signals from, the WTRUs 102a, 102b, 102c.

Each of the eNode-Bs 160a, 160b, 160c may be associated with a particular cell (not shown) and may be configured to handle radio resource management decisions, handover decisions, scheduling of users in the uplink and/or downlink, and/or the like. As shown in FIG. 1D, the eNode-Bs 160a, 160b, 160c may communicate with one another over an X2 interface.

The core network 106 shown in FIG. 1D may include a mobility management gateway (MME) 162, a serving gateway 164, and a packet data network (PDN) gateway 166. While each of the foregoing elements are depicted as part of the core network 106, any one of these elements may be owned and/or operated by an entity other than the core network operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and/or the like. The MME 162 may provide a control plane function for switching between the RAN 104 and other RANs (not shown) that employ other radio technologies, such as GSM or WCDMA.

The serving gateway 164 may be connected to each of the eNode Bs 160a, 160b, 160c in the RAN 104 via the S1 interface. The serving gateway 164 may generally route and forward user data packets to/from the WTRUs 102a, 102b, 102c. The serving gateway 164 may also perform other functions, such as anchoring user planes during inter-eNode B handovers, triggering paging when downlink data is available for the WTRUs 102a, 102b, 102c, managing and storing contexts of the WTRUs 102a, 102b, 102c, and/or the like.

The serving gateway 164 may also be connected to the PDN gateway 166, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

FIG. 1E is an example system diagram of the RAN 104 and the core network 106. The RAN 104 may be an access service network (ASN) that employs IEEE 802.16 radio technology to communicate with the WTRUs 102a, 102b, 102c over the air interface 116. The communication links between the different functional entities of the WTRUs 102a, 102b, 102c, the RAN 104, and the core network 106 may be defined as reference points.

As shown in FIG. 1E, the RAN 104 may include base stations 180a, 180b, 180c, and/or an ASN gateway 182, though the RAN 104 may include any number of base stations and/or ASN gateways. The base stations 180a, 180b, 180c may each be associated with a particular cell (not shown) in the RAN 104 and may each include one or more transceivers for communicating with the WTRUs 102a, 102b, 102c over the air interface 116. The base stations 180a, 180b, 180c may implement MIMO technology. The base stations 180a, 180b, 180c may each use multiple antennas to transmit wireless signals to, and/or receive wireless signals from, the WTRUs 102a, 102b, 102c. The base stations 180a, 180b, 180c may provide mobility management functions, such as handoff triggering, tunnel establishment, radio resource management, traffic classification, quality of service (QoS) policy enforcement, and/or the like. The ASN gateway 182 may serve as a traffic aggregation point and may be responsible for paging, caching of subscriber profiles, routing to the core network 106, and/or the like.

The air interface 116 between the WTRUs 102a, 102b, 102c and the RAN 104 may be defined as an R1 reference point that implements the IEEE 802.16 specification. In addition, each of the WTRUs 102a, 102b, 102c may establish a logical interface (not shown) with the core network 106. The logical interface between the WTRUs 102a, 102b, 102c and the core network 106 may be defined as an R2 reference point, which may be used for authentication, authorization, IP host configuration management, and/or mobility management.

The communication link between each of the base stations 180a, 180b, 180c may be defined as an R8 reference point that includes protocols for facilitating WTRU handovers and the transfer of data between base stations. The communication link between the base stations 180a, 180b, 180c and/or the ASN gateway 182 may be defined as an R6 reference point. The R6 reference point may include protocols for facilitating mobility management based on mobility events associated with each of the WTRUs 102a, 102b, 102c.

As shown in FIG. 1E, the RAN 104 may be connected to the core network 106. The communication link between the RAN 104 and the core network 106 may defined as an R3 reference point that includes protocols for facilitating data transfer and mobility management capabilities, for example. The core network 106 may include a mobile IP home agent (MIP-HA) 184, an authentication, authorization, accounting (AAA) server 186, and/or a gateway 188. While each of the foregoing elements are depicted as part of the core network 106, any one of these elements may be owned and/or operated by an entity other than the core network operator.

The MIP-HA 184 may be responsible for IP address management, and may enable the WTRUs 102a, 102b, 102c to roam between different ASNs and/or different core networks. The MIP-HA 184 may provide the WTRUs 102a, 102b, 102c with access to packet-switched networks, such as the Internet 110, to facilitate communications between the WTRUs 102a, 102b, 102c and IP-enabled devices. The AAA server 186 may be responsible for user authentication and for supporting user services. The gateway 188 may facilitate interworking with other networks. For example, the gateway 188 may provide the WTRUs 102a, 102b, 102c with access to circuit-switched networks, such as the PSTN 108, to facilitate communications between the WTRUs 102a, 102b, 102c and traditional land-line communications devices. The gateway 188 may provide the WTRUs 102a, 102b, 102c with access to the networks 112, which may include other wired or wireless networks that are owned and/or operated by other service providers.

Although not shown in FIG. 1E, the RAN 104 may be connected to other ASNs and/or the core network 106 may be connected to other core networks. The communication link between the RAN 104 the other ASNs may be defined as an R4 reference point, which may include protocols for coordinating the mobility of the WTRUs 102a, 102b, 102c between the RAN 104 and the other ASNs. The communication link between the core network 106 and the other core networks may be defined as an R5 reference, which may include protocols for facilitating interworking between home core networks and visited core networks.

The subject matter disclosed herein may be used, for example, in any of the networks or suitable network elements disclosed above. For example, the frame prioritization described herein may be applicable to a WTRU 102a, 102b, 102c or any other network element processing video data.

In video compression and transmission, frame prioritization may be implemented to prioritize the transmission of frames over a network. Frame prioritization may be implemented for Unequal Error Protection (UEP), frame dropping for bandwidth adaptation, Quantization Parameter (QP) control for enhanced video quality, and/or the like. High Efficiency Video Coding (HEVC) may include next-generation high definition television (HDTV) displays and/or internet protocol television (IPTV) services, such as for error resilient streaming in HEVC-based IPTV. HEVC may include features such as extended prediction block sizes (e.g., up to 64×64), large transform block sizes (e.g., up to 32×32), tile and slice picture segmentations for loss resilience and parallelism, adaptive loop filter (ALF), sample adaptive offset (SAO), and/or the like. HEVC may indicate frame or slice priority in a Network Abstraction Layer (NAL) level. A transmission layer may obtain priority information for each frame and/or slice by digging into a video coding layer and may indicate frame and/or slice priority-based differentiated services to improve Quality of Service (QoS) in video streaming.

Layer information of video packets may be used for frame prioritization. Video streams, such as the encoded bitstream of H.264 Scalable Video Coding(SVC) for example, may include a base layer and one or more enhancement layers. The reconstruction pictures of the base layer may be used to decode the pictures of the enhancement layers. Because the base layer may be used to decode the enhancement layers, losing a single base layer packet may result in severe error propagation in both layers. The video packets of the base layer may be processed with higher priority (e.g., the highest priority). The video packets with higher priority, such as the video packets of the base layer, may be transmitted with greater reliability (e.g., on more reliable channels) and/or lower packet loss rates.

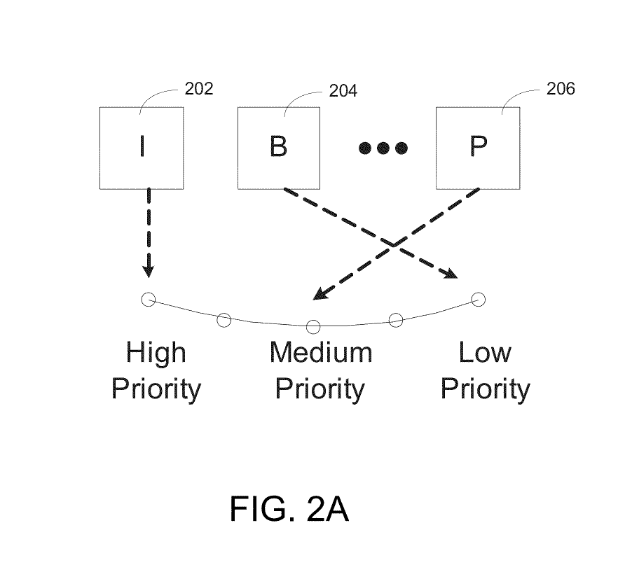

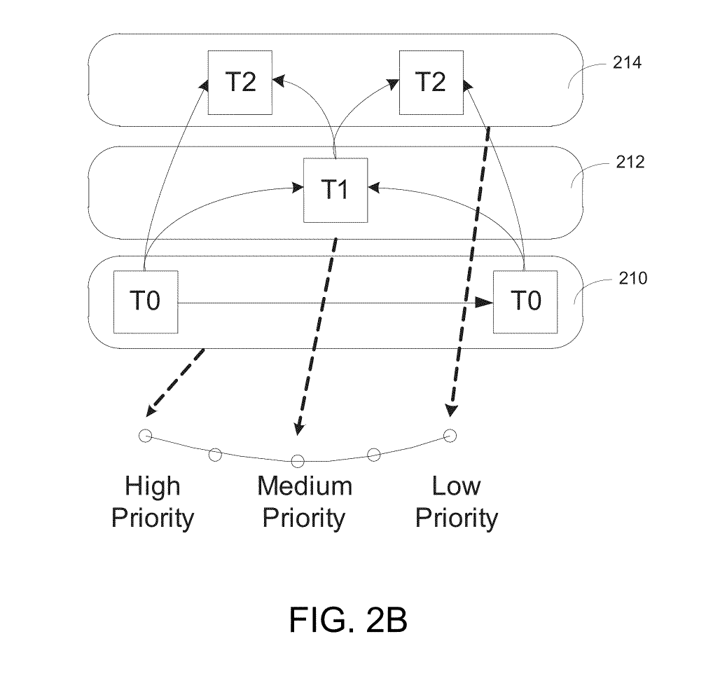

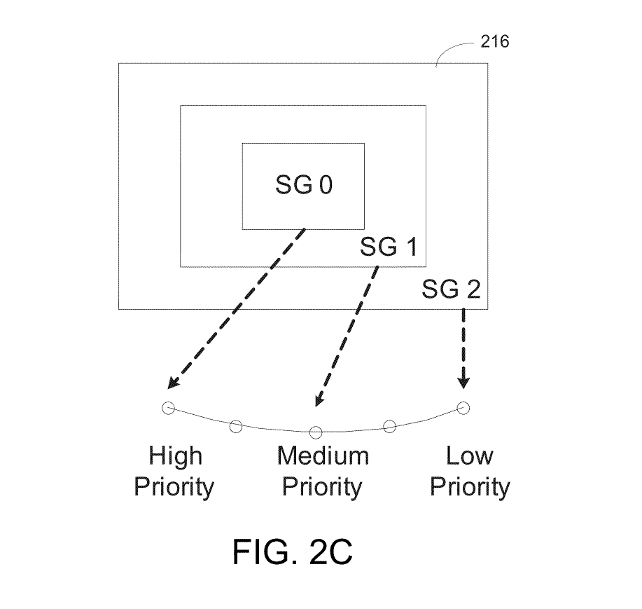

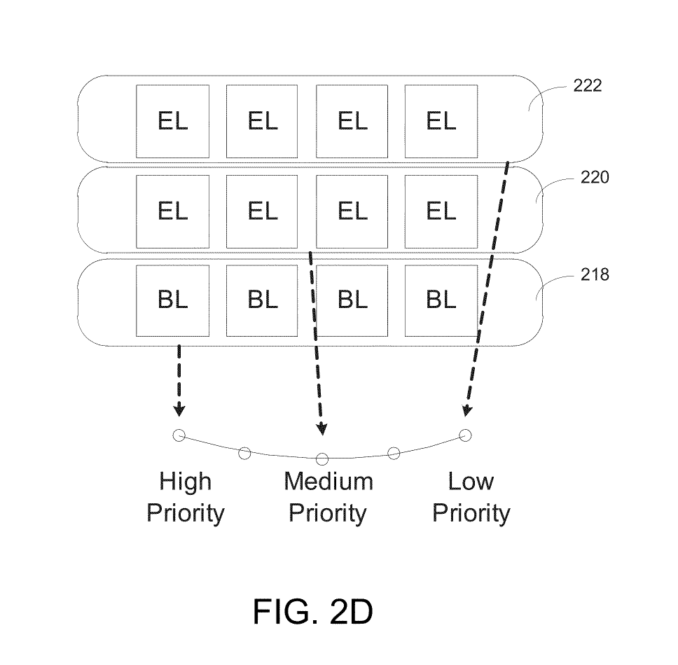

FIGS. 2A-2D are diagrams that depict different types of frame prioritization based on frame characteristics. Frame type information, as shown in FIG. 2A, may be used for frame prioritization. FIG. 2A shows an I-frame 202, a B-frame 204, and a P-frame 206. The I-frame 202 may not rely on other frames or information to be decoded. The B-Frame 204 and/or the P-Frame 206 may be inter-frames that may rely on the I-frame 202 as a reliable reference for being decoded. The P-frame 206 may be predicted from an earlier I-frame, such as I-frame 202, and may use less coding data (e.g., about 50% less coding data) than the I-frame 202. The B-frame 204 may use less coding data than the P-frame 206 (e.g., about 25% less coding data). The B-frame 204 may be predicted or interpolated from an earlier and/or later frame.

The frame type information may be related to temporal reference dependency for frame prioritization. For example, the I-frame 202 may be given higher priority than other frame types, such as the B-frame 204 and/or the P-frame 206. This may be because the B-frame 204 and/or the P-frame 206 may rely on the I-frame 202 for being decoded.

FIG. 2B depicts the use of temporal level information for frame prioritization. As shown in FIG. 2B, video information may be in hierarchical structure, such as a hierarchical B structure, that may include one or more temporal levels, such as temporal level 210, temporal level 212, and/or temporal level 214. The frames in one or more lower levels may be referenced by the frames in a higher level. The video frames at a higher level may not be referenced by lower levels. Temporal level 210 may be a base temporal level. Level 212 may be at a higher temporal level than level 210 and the video frame T1 in the temporal level 212 may reference the video frames T0 at temporal level 210. Temporal level 214 may be at a higher level than level 212 and may reference the video frame T1 at the temporal level 212 and/or the video frames T0 at the temporal level 210.

The video frames at a lower temporal level may be given higher priority than the video frames at higher temporal level that may reference the frames at the lower levels. For example, the video frames T0 at temporal level 210 may be given higher priority (e.g., highest priority) than the video frames T1 or T2 at temporal levels 212 and 214, respectively. The video frame T1 at temporal level 212 may be given higher priority (e.g., medium priority) than the video frames T2 at level 214. The video frames T2 at level 214 may be given a lower priority (e.g., low priority) than the video frames T0 at level 210 and/or the video frame T1 at level 212, to which the video frames T2 may refer.

FIG. 2C depicts the use of location information of slice groups (SGs) for frame prioritization, which may be referred to as SG-level prioritization. SGs may be used to divide a video frame 216 into regions. As shown in FIG. 2C, the video frame 216 may be divided into SG0, SG1, and/or SG2. SG0 may be given higher priority (e.g., high priority) than SG1 and/or SG2. This may be because SG0 is located at a more important position (e.g., toward the center) on the video frame 216 and may be determined to be more important to the user experience. SG1 may be given a lower priority than SG0 and a higher priority than SG2 (e.g., medium priority). This may be because SG1 is located closer to the center of the video frame 216 than SG2 and further from center than SG0. SG2 may be given a lower priority than SG1 and SG2 (e.g., low priority). This may be because SG2 is located further from the center of the video frame 216 than SG0 and SG1.

FIG. 2D depicts the use of scalable video coding (SVC) layer information for frame prioritization. Video data may be divided into different SVC layers, such as base layer 218, enhancement layer 220, and/or enhancement layer 222. The base layer 218 may be decoded to provide video at a base resolution or quality. The enhancement layer 220 may be decoded to build on the base layer 218 and may provide better video resolution and/or quality. The enhancement layer 222 may be decoded to build on the base layer 218 and/or the enhancement layer 220 to provide even better video resolution and/or quality.

Each SVC layer may be given a different priority level. The base layer 218 may be given a higher priority level (e.g., high priority) than the enhancement layer 220 and/or 222. This may be because the base layer 218 may be used to provide the video at a base resolution and the enhancement layers 220 and/or 222 may add on to the base layer 218. The enhancement layer 220 may be given a higher priority level than the enhancement layer 222 and a lower priority level (e.g., medium priority) than the base layer 218. This may be because the enhancement layer 220 may be used to provide the next layer of video resolution and may add on to the base layer 218. The enhancement layer 222 may be given a lower priority level (e.g., low priority) than the base layer 218 and the enhancement layer 220. This may be because the enhancement layer 222 may be used to provide an additional layer of video resolution and may add on to the base layer 218 and/or the enhancement layer 220.

As shown in FIGS. 2A-2C, I-frames, frames in a low temporal level, a slice group of a region of interest (ROI), and/or frames in a base layer of the SVC may have a higher priority level than other frames. Regarding the ROI, flexible macroblock ordering (FMO) may be performed in H.264 or the tiling in high efficiency video coding (HEVC) may be used. While FIGS. 2A-2D show low, medium, and high priority, the priority levels may vary within any range (e.g., high and low, a numeric scale, etc.) to indicate different levels of priority.

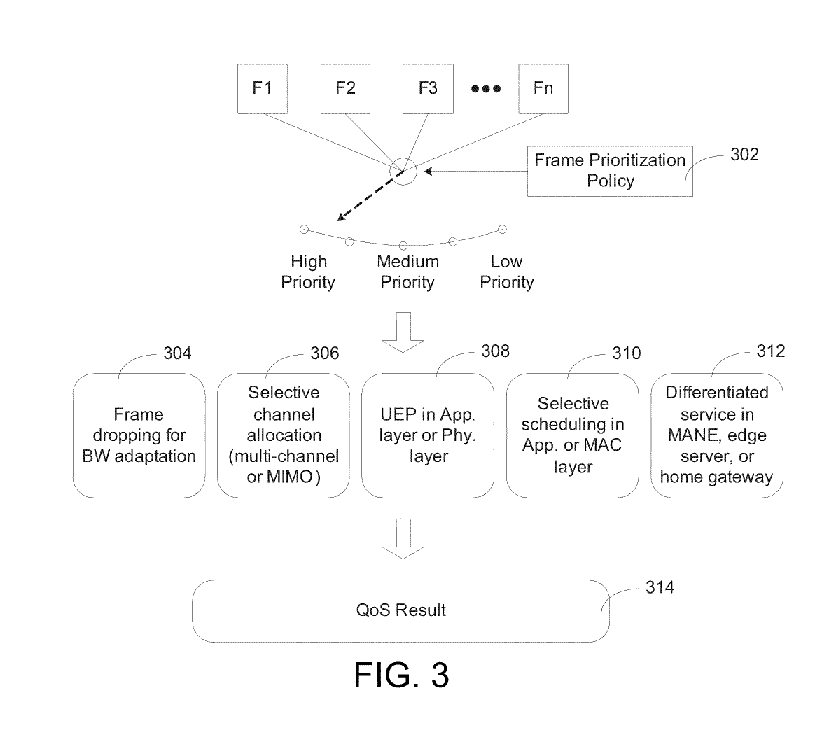

Frame prioritization may be used for QoS handling in video streaming FIG. 3 is a diagram that depicts examples of QoS handling using frame priority. A video encoder or other QoS component in a device may determine a priority of each frame F1, F2, F3, . . . Fₙ, where n may be a frame number. The video encoder or other QoS component may receive one or more frames F1, F2, F3, . . . Fₙ, and may implement a frame prioritization policy 302 to determine the priority of each of the one or more frames F1, F2, F3, . . . Fₙ. The frames F1, F2, F3, . . . Fₙ may be prioritized differently (e.g., high, medium, or low priority) based on the desired QoS result 314. The frame prioritization policy 302 may be implemented to achieve the desired QoS result 314.

Frame priorities may be used for several QoS purposes 304, 306, 308, 310, 312. Frames F1, F2, F3, . . . Fₙ may be prioritized at 304 for frame dropping for bandwidth adaptation. At 304, the frames F1, F2, F3, . . . Fₙ that are assigned a lower priority may be dropped in a transmitter or a scheduler of a transmitting device for bandwidth adaptation. Frames may be prioritized at 306 for selective channel allocation where multiple channels may be implemented, such as when multiple-input and multiple-output (MIMO) is implemented for example. Using the frame prioritization at 306, frames that are assigned a higher priority may be allocated to more stable channels or antennas. At 308, unequal error protection (UEP) in the application layer or the physical layer may be distributed according to priority. For example, frames that are assigned a higher priority may be protected with larger overhead of Forward Error Correction (FEC) code in the application layer or the physical layer. If a video server or transmitter protects the higher priority video frame with larger overhead of FEC, the video packet may be decoded with the error correction codes even if there are many packet losses in the wireless network.

Selective scheduling may be performed at 310 in the application layer and/or the medium access control (MAC) layer based on frame priority. Frames with a higher priority may be scheduled in the application layer and/or MAC layer before frames with a lower priority. At 312, different frame priorities may be used to differentiate services in a Media Aware Network Element (MANE), an edge server, or a home gateway. For example, the MANE smart router may drop the low priority frames when it is determined when there is network congestion, route the high priority frames to more a stable network channel/channels, apply higher FEC overhead to high priority frames, and/or the like.

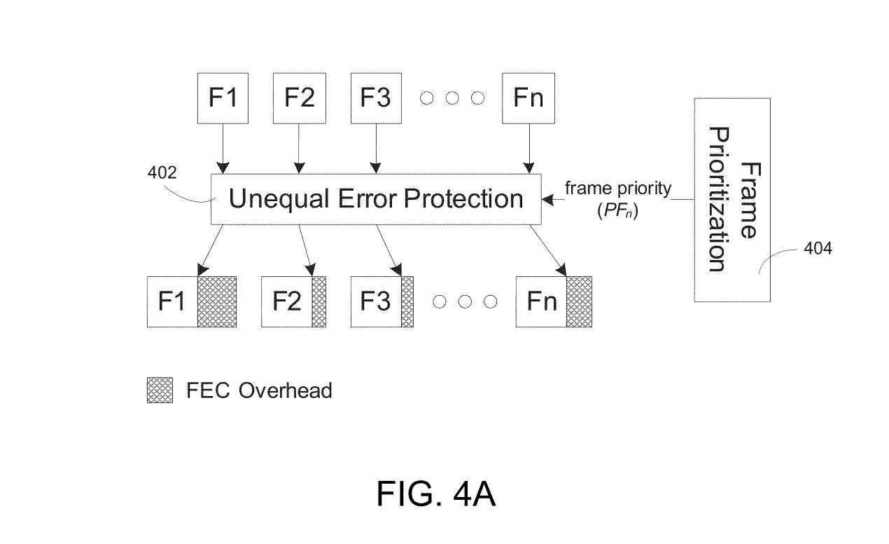

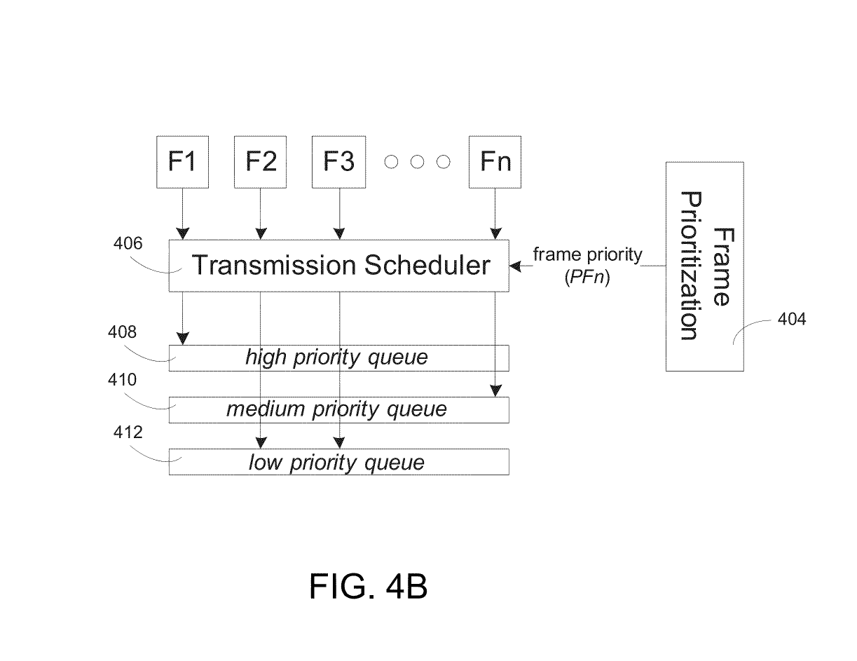

FIG. 4A shows an example of UEP being applied based on priority, as illustrated in FIG. 3 at 308 for example. The UEP module 402 may receive frames F1, F2, F3, . . . Fₙ and may determine the respective frame priority (PFₙ) for each frame. The frame priority PFₙ for each of frames F1, F2, F3, . . . Fₙ may be received from a frame prioritization module 404. The frame prioritization module 404 may include an encoder that may encode the video frames F1, F2, F3, . . . Fₙ with their respective priority. The UEP module 402 may apply a different FEC overhead to each of frames F1, F2, F3, . . . Fₙ based on the priority assigned to each frame. Frames that are assigned a higher priority may be protected with larger overhead of FEC code than frames that are assigned a lower priority.

FIG. 4B shows an example of selective transmission scheduling of frames F1, F2, F3, . . . Fₙ based on the priority assigned to each frame, as illustrated in FIG. 3 at 310 for example. As shown in FIG. 4B, a transmission scheduler 406 may receive frames F1, F2, F3, . . . Fₙ and may determine the respective frame priority (PFₙ) for each frame. The frame priority PFₙ for each of frames F1, F2, F3, . . . Fₙ may be received from a frame prioritization module 404. The transmission scheduler 406 may allocate frames F1, F2, F3, . . . Fₙ to different prioritized queues 408, 410, and/or 412 according to their respective frame priority. The high priority queue 408 may have a higher throughput than the medium priority queue 410 and the low priority queue 412. The medium priority queue 410 may have a lower throughput than the high priority queue 408 and a higher throughput than the low priority queue 412. The low priority queue 412 may have a lower throughput than the high priority queue 408 and the medium priority queue 410. The frames F1, F2, F3, . . . Fₙ with a higher priority may be assigned to a higher priority queue with a higher throughput. As shown in FIGS. 4A and 4B, once the priority of a frame is determined, the UEP module 402 and the transmission scheduler 406 may use the priority for robust streaming and QoS handling.

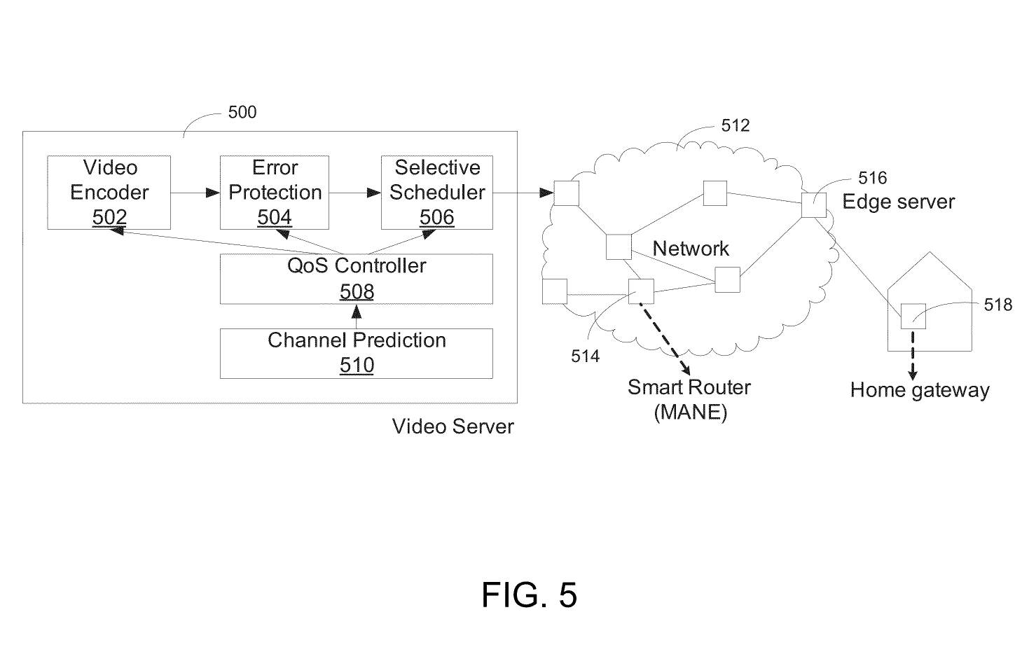

Technologies such as MPEG media transport (MMT) and Internet Engineering Task Force (IETF) H.264 over a real-time transport protocol (RTP) may implement frame priority at the system level, which may enhance a scheduling device (e.g., a video server or router) and/or a MANE smart router for QoS improvement by differentiating among packets with various priorities when congestion occurs in networks. FIG. 5 is a diagram of an example video streaming architecture, which may implement a video server 500 and/or a smart router (e.g., such as a MANE smart router) 514. As shown in FIG. 5, a video server 500 may be an encoding device that may include a video encoder 502, an error protection module 504, a selective scheduler 506, a QoS controller 508, and/or a channel prediction module 510. The video encoder 502 may encode an input video frame. The error protection module 504 may apply FEC codes to the encoded video frame according to a priority assigned to the video frame. The selective scheduler 506 may allocate the video frame to the internal sending queues according to the frame priority. If a frame is allocated to the higher priority sending queue, the frame may have more of a chance to be transmitted to a client in network congestion condition. The channel prediction module 510 may receive feedback from a client and/or monitor the network connections of a server to estimate the network conditions. The QoS controller 508 may decide the priority of a frame according to its own frame prioritization and/or the network condition estimated by the channel prediction module 510.

The smart router 514 may receive the video frames from the video server 500 and may send them through the network 512. The edge server 516 may be included in the network 512 and may receive the video frame from the smart router 514. The edge server 516 may send the video frame to a home gateway 518 for being handed over to a client device, such as a WTRU.

An example technique for assigning frame priority may be based on frame characteristics analysis. For example, layer information (e.g., base and enhancement layers), frame type (e.g., I-frame, P-frame, and/or B-frame), the temporal level of a hierarchical structure, and/or the frame context (e.g., important visual objects in frame) may be common factors in assigning frame priority. Examples are provided herein for hierarchical structure (e.g., hierarchical-B structure) based frame prioritization. The hierarchical structure may be a hierarchical structure in HEVC.

Video protocols, such as HEVC, may provide priority information for prioritization of video frames. For example, a priority ID may be implemented that may identify a priority level of a video frame. Some video protocols may provide a temporal ID (e.g., temp_id) in the packet header (e.g., Network Abstraction Layer (NAL) header). The temporal ID may be used to distinguish frames on different temporal levels by indicating a priority level associated with each temporal level. The priority ID may be used to distinguish frames on the same temporal level by indicating a priority level associated with each frame in a temporal level.

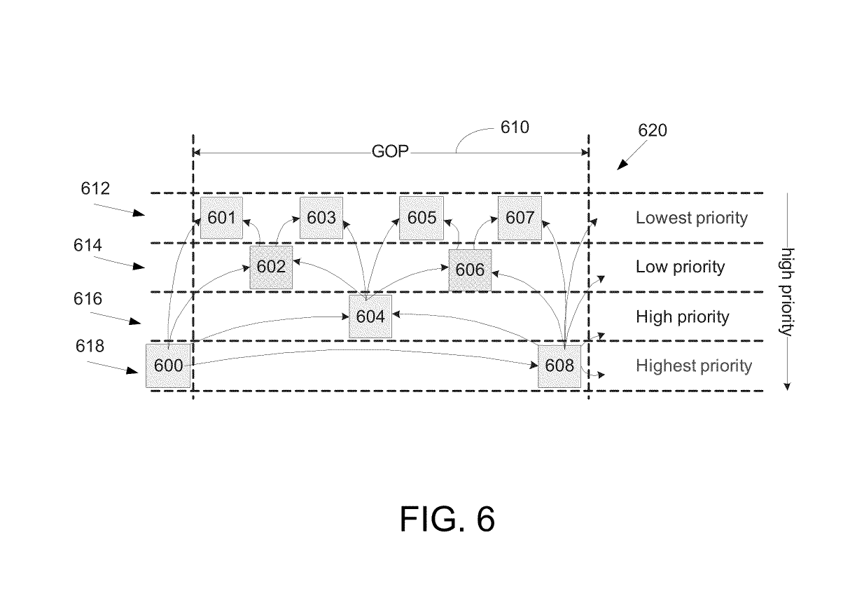

A hierarchical structure, such as a hierarchical B structure, may be implemented in the extension of H.264/AVC to increase coding performance and/or provide temporal scalability. FIG. 6 is a diagram that illustrates an example of uniform prioritization in a hierarchical structure 620, such as a hierarchical-B structure. The hierarchical structure 620 may include a group of pictures (GOP) 610 that may include a number of frames 601 to 608. Each frame may have a different picture order count (POC). For example, frames 601 to 608 may correspond to POC 1 to POC 8, respectively. The POC of each frame may indicate the position of the frame within a sequence of frames in an Intra Period. The frames 601 to 608 may include predicted frames (e.g., B-frames and/or P-frames) that may be determined from the I-frame 600 and/or other frames in the GOP 610. The I-frame 600 may correspond to POC 0.

The hierarchical structure 620 may include temporal levels 612, 614, 616, 618. Frames 600 and/or 608 may be included in temporal level 618, frame 604 may be included in temporal level 616, frames 602 and 606 may be included in temporal level 614, and frames 601, 603, 605, and 607 may be included in temporal level 612. The frames in a lower temporal level may have higher priority than frames in a higher temporal level. For example, the frames 600 and 608 may have a higher priority (e.g., highest priority) than frame 604, frame 604 may have a higher priority (e.g., high priority) than frames 602 and 606, and frames 602 and 606 may have a higher priority (e.g., low priority) than frames 601, 603, 605, and 607. The priority level of each frame in the GOP 610 may be based on the temporal level of the frame, the number of other frames from which the frame may be referenced, and/or the temporal level of the frames that may reference the frame. For example, the priority of a frame in a lower temporal level may have a higher priority because the frame in a lower temporal level may have more opportunities to be referenced by other frames. Frames at the same temporal level of the hierarchical structure 620 may have equal priority, such as in an example HEVC system that may have multiple frames in a temporal level for example. When the frames in a lower temporal level have a higher priority and the frames at the same temporal level have the same priority, this may be referred to as uniform prioritization.

FIG. 6 illustrates an example of uniform prioritization in a hierarchical structure, such as a hierarchical-B structure, where frame 602 and frame 606 have the same priority and frame 600 and frame 608 may have the same priority. The frames 602 and 606 and/or the frames 600 and 608 that are on the same temporal levels 614 and 618, respectively, may have a different level of importance. The level of importance may be determined according to a Reference Picture Set (RPS) and/or the size of a reference picture list.

Various types of frame referencing may be implemented when a frame is referenced by one or more other frames. To compare the importance of frames located in the same temporal level, such as frame 602 and frame 606, a position may be defined for each frame in a GOP, such as GOP 610. Frame 602 may be in Position A within the GOP 610. Frame 606 may be at Position B within the GOP 610. Position A for each GOP may be defined as the POC 2+N×GOP and Position B for each GOP may be defined as the POC 6+N×GOP, where, as shown in FIG. 6, the GOP include eight frames and N may represent the number of GOP(s). Using these positioning equations for an Intra Period that includes thirty-two frames, frames at POC 2, POC 10, POC 18, and POC 26 may belong to Position A, and frames at POC 6, POC 14, POC 22, and POC 30 may belong to Position B.

Table 1 shows a number of characteristics associated with each frame in an Intra Period of thirty-two frames. The Intra Period may include four GOPs, with each GOP including eight frames having consecutive POCs. Table 1 shows the QP offset, the reference buffer size, the RPS, and the reference picture lists (e.g., L0 and L1) for each frame. The reference picture lists may indicate the frames that may be referenced by a given video frame. The reference picture lists may be used for encoding each frame, and may be used to influence video quality.

TABLE 1
Video Frame Characteristics (RA setting, GOP 8, Intra Period 32)

| | | Reference | | Reference Picture | | | | | | | | | | | |
|---|---|---|---|---|---|---|---|---|---|---|---|---|---|---|---|
| | QP | Buffer size | Temporal | Set | | | | Reference Picture Lists | | | | | | | |
| Frame | Offset | (L0 and L1) | ID | (RPS) | | | | L0 | | | | L1 | | | |
| 0 | | | | | | | | | | | | | | | |
| 8 | 1 | 4 | 0 | −8 | −10 | −12 | −16 | 0 | | | | 0 | | | |
| 4 | 2 | 2 | 0 | −4 | −6 | 4 | | 0 | 8 | | | 8 | 0 | | |
| 2 | 3 | 2 | 0 | −2 | −4 | 2 | 6 | 0 | 4 | | | 4 | 8 | | |
| 1 | 4 | 2 | 0 | −1 | 1 | 3 | 7 | 0 | 2 | | | 2 | 4 | | |
| 3 | 4 | 2 | 0 | −1 | −3 | 1 | 5 | 2 | 0 | | | 4 | 8 | | |
| 6 | 3 | 2 | 0 | −2 | −4 | −6 | 2 | 4 | 2 | | | 8 | 4 | | |
| 5 | 4 | 2 | 0 | −1 | −5 | 1 | 3 | 4 | 0 | | | 6 | 8 | | |
| 7 | 4 | 2 | 0 | −1 | −3 | −7 | 1 | 6 | 4 | | | 8 | 6 | | |
| 16 | 1 | 4 | 0 | −8 | −10 | −12 | −16 | 8 | 6 | 4 | 0 | 8 | 6 | 4 | 0 |
| 12 | 2 | 2 | 0 | −4 | −6 | 4 | | 8 | 6 | | | 16 | 8 | | |
| 10 | 3 | 2 | 0 | −2 | −4 | 2 | 6 | 8 | 6 | | | 12 | 16 | | |
| 9 | 4 | 2 | 0 | −1 | 1 | 3 | 7 | 8 | 10 | | | 10 | 12 | | |
| 11 | 4 | 2 | 0 | −1 | −3 | 1 | 5 | 10 | 8 | | | 12 | 16 | | |
| 14 | 3 | 2 | 0 | −2 | −4 | −6 | 2 | 12 | 10 | | | 16 | 12 | | |
| 13 | 4 | 2 | 0 | −1 | −5 | 1 | 3 | 12 | 8 | | | 14 | 16 | | |
| 15 | 4 | 2 | 0 | −1 | −3 | −7 | 1 | 14 | 12 | | | 16 | 14 | | |
| 24 | 1 | 4 | 0 | −8 | −10 | −12 | −16 | 16 | 14 | 12 | 8 | 16 | 14 | 12 | 8 |
| 20 | 2 | 2 | 0 | −4 | −6 | 4 | | 16 | 14 | | | 24 | 16 | | |
| 18 | 3 | 2 | 0 | −2 | −4 | 2 | 6 | 16 | 14 | | | 20 | 24 | | |
| 17 | 4 | 2 | 0 | −1 | 1 | 3 | 7 | 16 | 18 | | | 18 | 20 | | |
| 19 | 4 | 2 | 0 | −1 | −3 | 1 | 5 | 18 | 16 | | | 20 | 24 | | |
| 22 | 3 | 2 | 0 | −2 | −4 | −6 | 2 | 20 | 18 | | | 24 | 20 | | |
| 21 | 4 | 2 | 0 | −1 | −5 | 1 | 3 | 20 | 16 | | | 22 | 24 | | |
| 23 | 4 | 2 | 0 | −1 | −3 | −7 | 1 | 22 | 20 | | | 24 | 22 | | |
| 32 | | | | | | | | | | | | | | | |
| 28 | 2 | 2 | 0 | −4 | −6 | 4 | | 24 | 22 | | | 32 | 24 | | |
| 26 | 3 | 2 | 0 | −2 | −4 | 2 | 6 | 24 | 22 | | | 28 | 32 | | |
| 25 | 4 | 2 | 0 | −1 | 1 | 3 | 7 | 24 | 26 | | | 26 | 28 | | |
| 27 | 4 | 2 | 0 | −1 | −3 | 1 | 5 | 26 | 24 | | | 28 | 32 | | |
| 30 | 3 | 2 | 0 | −2 | −4 | −6 | 2 | 28 | 26 | | | 32 | 28 | | |
| 29 | 4 | 2 | 0 | −1 | −5 | 1 | 3 | 28 | 24 | | | 30 | 32 | | |
| 31 | 4 | 2 | 0 | −1 | −3 | −7 | 1 | 30 | 28 | | | 32 | 30 | | |

| | | |
|---|---|---|
| The amount of appearance in reference picture list (L0 | Position A | Position B |
| and L1) | 12 | 6 |

*count once if the ref POC. number is in both L0 and L1

Table 1 illustrates the frequency with which the frames in Position A and Position B appear in the reference picture lists (e.g., L0 and L1). Position A and Position B may appear in the reference picture lists (e.g., L0 and L1) at different times during each Intra Period. The frames in Position A and Position B may be determined by counting the number of times a POC for a frame in Position A or Position B appears in the reference picture lists (e.g., L0 and L1). Each POC may be counted once for each time it appears in a reference picture list (e.g., L0 and/or L1) for a given frame in Table 1. If a POC was referenced in multiple picture lists (e.g., L0 and L1) for a frame, the POC may be counted once for that frame. In Table 1, the frames in Position A (e.g., at POC 2, POC 10, POC 18, and POC 26) are referenced 12 times and the frames in Position B (e.g., at POC 6, POC 14, POC 22, and POC 30) are referenced 16 times during the Intra Period. Compared to the frames in Position A, the frames in Position B may have more chances to be referenced. This may indicate that the frames in Position B may be more likely to cause error propagation if they are dropped during transmission. If a frame is more likely to cause error propagation than another frame, the frame may be given higher priority than frames that are less likely to cause error propagation.

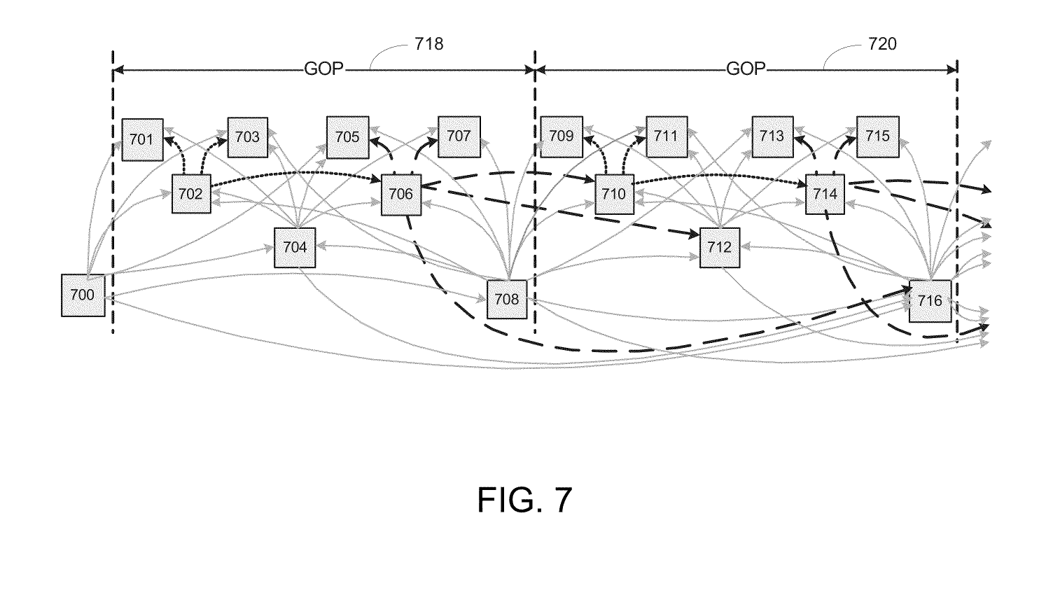

FIG. 7 is a diagram that depicts a frame referencing scheme of an RA setting. FIG. 7 shows two GOPs 718 and 720 of the RA setting. The GOP 718 includes frames 701 to 708. The GOP 720 includes frames 709 to 716. The frames in GOP 718 and GOP 720 may be part of the same Intra Period. Each frame in the Intra Period may have a different POC. For example, frames 700 to 716 may correspond to POC 1 to POC 16, respectively. Frame 700 may be an I-frame that may begin the Intra Period. The frames 701 to 716 may include predicted frames (e.g., B-frames and/or P-frames) that may be determined from the I-frame 700 and/or other frames in the Intra Period.

FIG. 7 shows the relationship of frame referencing amongst the frames within GOPs 718 and 720. The frames at Position A within GOP 718 and GOP 720 may include frame 702 and frame 710, respectively. The frames at Position A may be referenced by the frames indicated at the end of the dotted arrows. For example, frame 702 may be referenced by frame 701, frame 703, and frame 706. Frame 710 may be referenced by frame 709, frame 711, and frame 714. The frames at Position B within GOP 718 and GOP 720 may include frame 706 and frame 714, respectively. The frames at Position B may be referenced by the frames indicated at the end of the dashed arrows. For example, frame 706 may be referenced by frame 705, frame 707, frame 710, frame 712, and frame 716. Frame 714 may be referenced by frame 713, frame 715, and at least three other frames in the next GOP of the Intra Period (not shown). As frame 706 and frame 714 may be referenced by more video frames than the other video frames on the same temporal level (e.g., frame 702 and frame 710), the video quality may be degraded more severely if frame 706 and/or frame 714 are lost. As a result, frame 706 and/or frame 714 may be given higher priority than frame 702 and/or frame 710.

Error propagation may be effected when packets or frames are dropped. To quantify video quality degradation, frame dropping tests may be performed with encoded bitstreams (e.g., binary video files). Frames in different positions within a GOP may be dropped to determine the effect of a dropped packet at each position. For example, a frame in Position A may be dropped to determine the effect of the loss of the frame at Position A. A frame in Position B may be dropped to determine the effect of the loss of the frame at Position B. There may be multiple dropping periods. A dropping period may occur in each GOP. One or more dropping periods may occur in each Intra Period.

Video coding, via H.264 and/or HEVC for example, may be used to encapsulate a compressed video frame in NAL unit(s). An NAL packet dropper may analyze the video packet type with the encoded bitstream and may distinguish each frame. A NAL packet dropper may be used to consider the effect of error propagation. To illustrate, to measure the difference of objective video quality in two tests (e.g., one dropped frame in Position A and one dropped frame in Position B), the video decoder may decode a damaged bitstream using an error concealment, such as frame copy for example, and may generate a video file (e.g., a YUV-formatted raw video file).

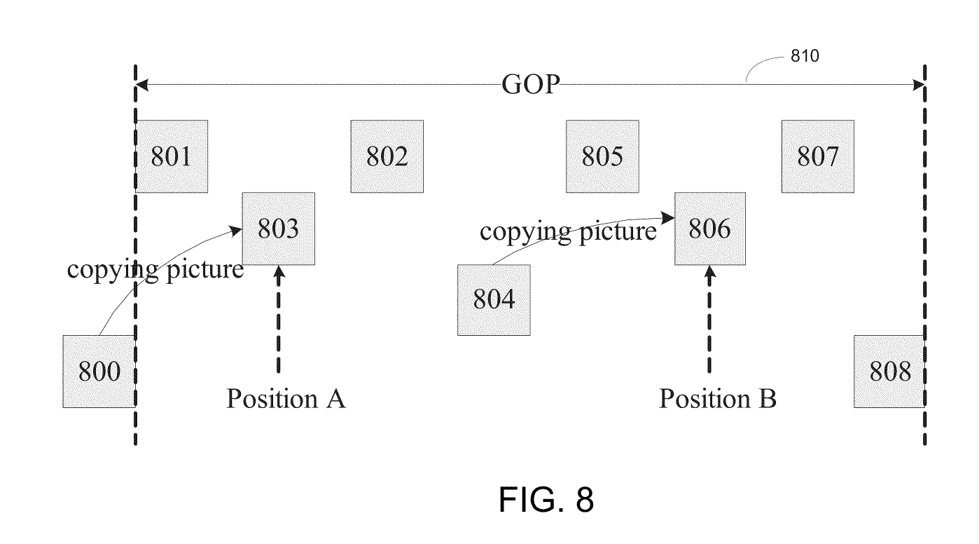

FIG. 8 is a diagram that depicts an example form of error concealment. FIG. 8 shows a GOP 810 that includes frames 801 to 808. The GOP 810 may be part of an Intra Period that may begin with frame 800. Frames 803 and 806 may represent frames at Position A and Position B, respectively, within the GOP 810. Frame 803 and/or frame 806 may be lost or dropped. Error concealment may be performed on the lost or dropped frames 803 and/or 806. The error concealment illustrated in FIG. 8 may use frame copy. The decoder used for performing the error concealment may be an HEVC model (HM) decoder, such as an HM 6.1 decoder for example.

After frame 803 in Position A or frame 806 in Position B is lost or dropped during transmission, the decoder may copy a previous reference frame. For example, if frame 803 is lost or dropped, frame 800 may be copied to the location of frame 803. Frame 800 may be copied because frame 800 may be referenced by frame 803 and may be temporally advanced. If frame 806 is lost, frame 804 may be copied to the location of frame 806. The copied frame may be a frame on a lower temporal level.

After the error concealed frame is copied, error propagation may continue until the decoder may have an intra-refresh frame. The intra-refresh frame may be in the form of an instantaneous decoder refresh (IDR) frame or a clean random access (CRA) frame. The intra-refresh frame may indicate that frames after the IDR frame may be unable to reference any frame before it. Because the error propagation may be continued until the next IDR or CRA frame, the loss of important frames may be prevented for video streaming.

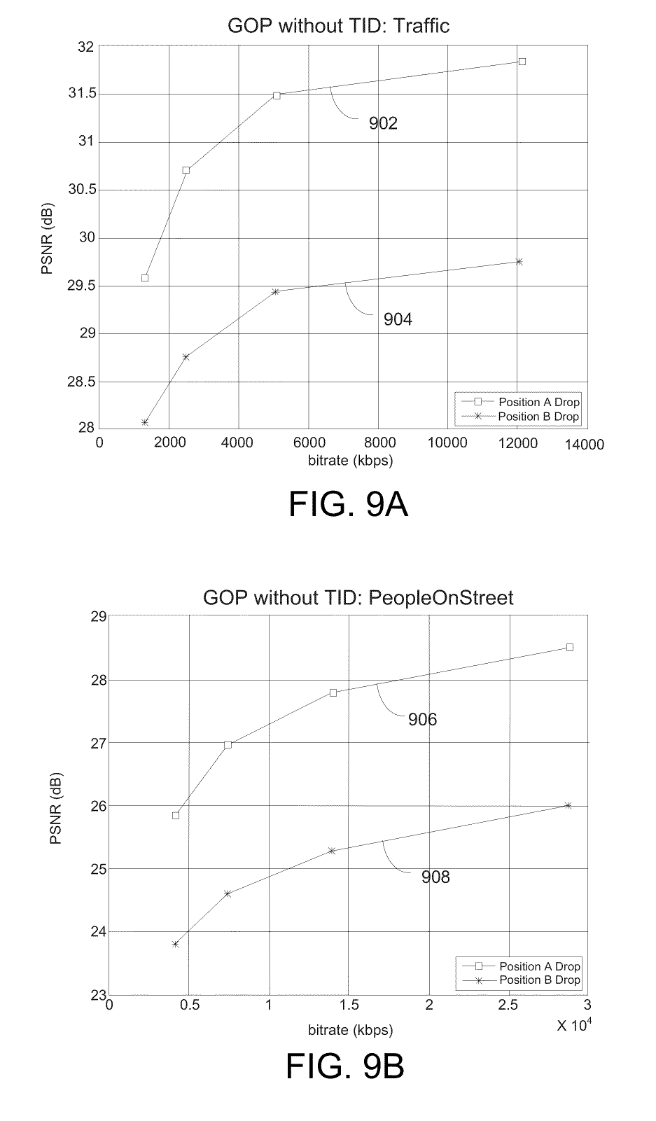

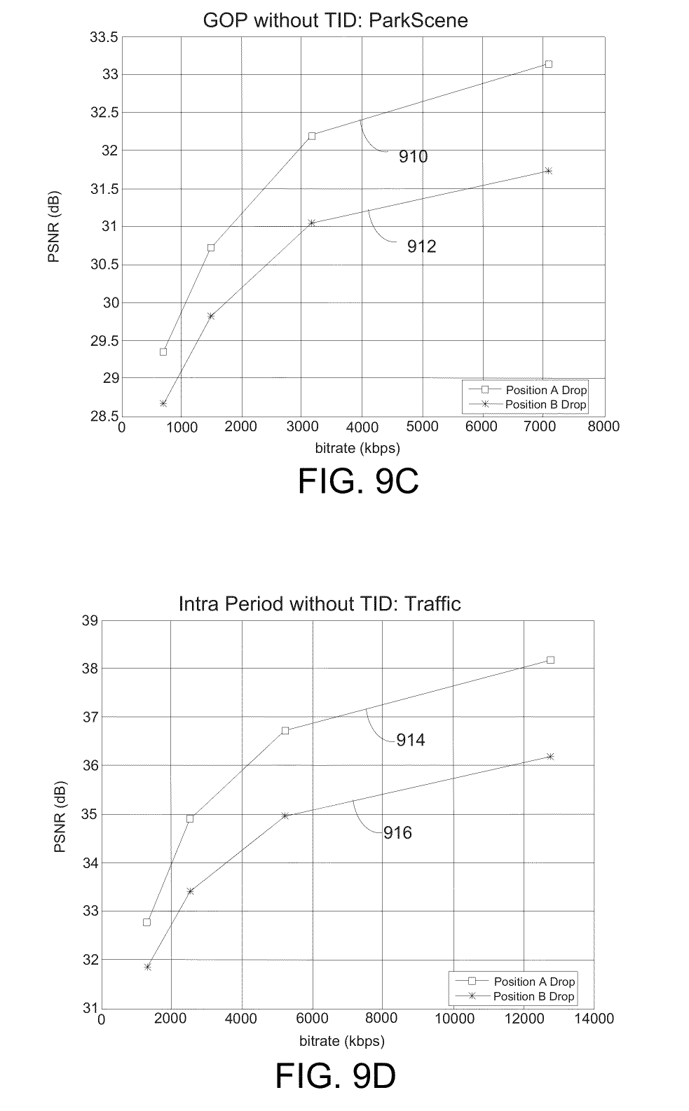

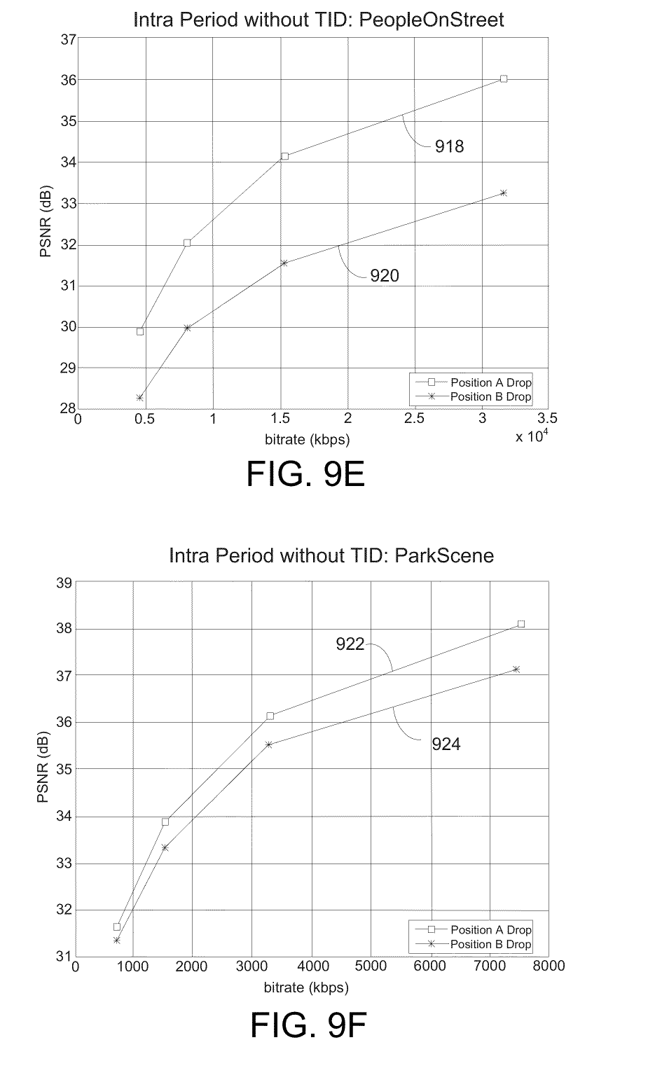

Table 2 and FIGS. 9A-9F illustrate a BD-rate gain between a Position A drop and Position B drop. Table 2 shows the BD-rate gain for frame dropping tests conducted with the frame sequences for Traffic, PeopleOnStreet, and ParkScene. A frame was dropped per each GOP for each sequence. A frame was dropped per each intraperiod for each sequence. As shown in Table 2, the peak signal-to-noise ratio (PSNR) of a Position A drop may be 71.2 percent and 40.6 percent better than the PSNR of a Position B drop in a BD-rate.

TABLE 2
BD-rate gains of Position A drop compared to a Position B drop

| | Random Access (RA), Main Profile | | | | | |
|---|---|---|---|---|---|---|
| | | | | Drop 1 frame per | | |
| | Drop 1 frame per GOP | | | IntraPeriod | | |
| Sequence name | Y | U | V | Y | U | V |
| Traffic | −85.4% | −11.3% | −33.4% | −48.7% | −5.6% | −13.4% |
| PeopleOnStreet | −83.7% | −37.4% | −36.7% | −54.0% | −12.3% | −12.4% |
| ParkScene | −44.6% | −14.7% | −8.5% | −19.0% | −5.2% | −3.0% |
| Overall | −71.2% | −21.1% | −26.2% | −40.6% | −7.7% | −9.6% |

To measure the difference in video quality between two packet dropping tests (e.g., one dropped frame in Position A and one dropped frame in Position B), a decoder (e.g., an HM v6.1 decoder) may be used. The decoder may conceal lost frames using frame copy. The testing may use three test sequences from HEVC common test conditions. The resolution of the pictures being analyzed may be 2560×1600 and/or 1920×1080.

The same or similar results may be illustrated in the rate-distortion curves shown in the graphs in FIGS. 9A-9F, where the frame in Position B may be indicated as being more important than the frame in Position A. FIGS. 9A-9F are graphs that illustrate the BD-rate gain for frame drops at two frame positions (e.g., Position A and Position B). FIGS. 9A-9F illustrate frame drops at Position A on lines 902, 906, 910, 914, 918, and 922. Frame drops at Position B are illustrated on lines 904, 908, 912, 916, 920, and 924. Each line shows the average PSNR of the decoded frames with the frame drops in different bitrates. In FIGS. 9A, 9B, and 9C a frame is dropped at Position A and at Position B per GOP without a temporal ID (TID) (e.g., TID=0). In FIGS. 9D, 9E, and 9F a frame is dropped at Position A and at Position B per Intra Period without TID. FIGS. 9A and 9D illustrate the BD-rate gain for picture 1. FIGS. 9B and 9E illustrate the BD-rate gain for picture 2. FIGS. 9C and 9F illustrate the BD-rate gain for picture 3.

As shown in FIGS. 9A-9F, the BD-rate for position A drops was higher than the BD-rate for Position B drops. As shown in FIGS. 9D-9F, the PSNR degradation caused by dropping a picture per Intra Period in Position A may be less than the PSNR degradation caused by dropping pictures in Position B. This may indicate that pictures in the same temporal level in hierarchical pictures may have different priorities in accordance with their prediction information.

As shown in Table 2, and FIGS. 9A-9F, the frames in the same temporal level in hierarchical structure may influence video quality differently and may provide, use, and/or be assigned different priorities while being located in the same temporal level. Frame prioritization may be performed to mitigate the loss of higher priority frames. Frame prioritization may be based on prediction information. Frame prioritization may be performed explicitly or implicitly. An encoder may perform explicit frame prioritization by counting the number of referenced macro blocks (MBs) or coding units (CUs) in a frame. The encoder may count the number of referenced MBs or CUs in a frame when the MB or CU is referenced by another frame. The encoder may update the priority of each frame based on the number of explicitly referenced MBs or CUs in the frame. If the number is greater, the priority of the frame may be set higher. An encoder may perform implicit prioritization by assigning a priority to frames according to the RPS and the reference buffer size (e.g., L0 and L1) of the encoding option.

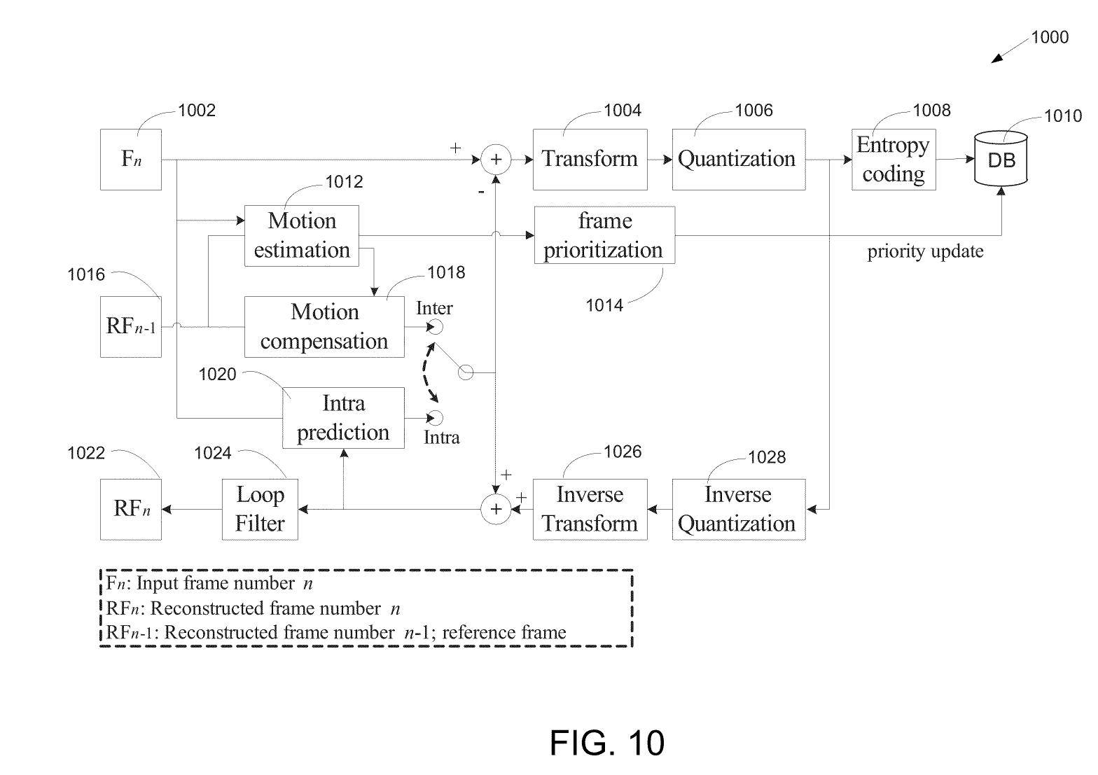

FIG. 10 is a diagram that depicts example modules that may be implemented for performing explicit frame prioritization. As shown in FIG. 10, a frame Fₙ 1002 may be received at an encoder 1000. The frame may be sent to the transform module 1004, the quantization module 1006, the entropy coding module 1008, and/or may be a stored video bitstream (SVB) at 1010. In the transform module 1004, the input raw video data (e.g., video frames) may be transformed from spatial domain data to frequency domain data. The quantization module 1006 may quantize the video data received from the transform module 1004. The quantized data may be compressed by the entropy coding module 1008. The entropy coding module 1008 may include a context-adaptive binary arithmetic coding module (CABAC) or a context-adaptive variable-length coding module (CAVLC). The video data may be stored at 1010 as an NAL bitstream for example.

The frame Fₙ 1002 may be received at a motion estimation module 1012. The frame may be sent from the motion estimation module 1012 to a frame prioritization module 1014. The priority may be determined at the frame prioritization module 1014 based on the number of MBs or CUs referenced in the frame Fₙ 1002. The frame prioritization module may update the number of referenced MBs or CUs using information from the motion estimation module 1012. For example, the motion estimation module 1012 may indicate which MBs or CUs in the reference frame match the current MB or CU in the current frame. The priority information for frame Fₙ 1002 may be stored as the SVB at 1010.

There may be multiple prediction modes for encoding video frames. The prediction modes may include intra-frame prediction and inter-frame prediction. The intra-frame prediction module 1020 may be conducted in the spatial domain by referring to neighboring samples of previously-coded blocks. The inter-frame prediction may use the motion estimation module 1012 and/or motion compensation module 1018 to find the matched blocks between the current frame and the reconstructed frame number n−1 (RFₙ₋₁ 1016) that was previously-coded, reconstructed, and/or stored. Because the video encoder 1000 may use the reconstructed frame RFₙ 1022 as the decoder does, the encoder 1000 may use the inverse quantization module 1028 and/or the inverse transform module 1026 for reconstruction. These modules 1028 and 1026 may generate the reconstructed frame RFₙ 1022 and the reconstructed frame RFₙ 1022 may be filtered by the loop filter 1024. The reconstructed frame RFₙ 1022 may be stored for later use.

Prioritization may be conducted using the counted numbers periodically, which may update the priorities of the encoded frames (e.g., the priority field in NAL header). A frame prioritization period may be decided by the absolute number of maximum value in an RPS. If the RPS is set as shown in Table 3, the frame prioritization period may be 16 (e.g., for two GOPs), and the encoder may update the priorities for encoded frames once every 16 frames or any suitable number of frames. A priority update using explicit prioritization may cause a delay in transmission compared to implicit prioritization. Explicit frame prioritization may provide more precise priority information than implicit frame prioritization, which may calculate priorities implicitly using the RPS and/or reference picture list size. Explicit frame prioritization and/or implicit frame prioritization may be used for video streaming scenario, video conferencing, and/or any other video scenario.

TABLE 3
Example of RPS (GOP 8)

| | |
|---|---|
| | Reference Picture Set |
| POC | (RPS) |

| | | | | |
|---|---|---|---|---|
| 8 | −8 | −10 | −12 | −16 |
| 4 | −4 | −6 | 4 | |
| 2 | −2 | −4 | 2 | 6 |
| 1 | −1 | 1 | 3 | 7 |
| 3 | −1 | −3 | 1 | 5 |
| 6 | −2 | −4 | −6 | 2 |
| 5 | −1 | −5 | 1 | 3 |
| 7 | −1 | −3 | −7 | 1 |

In implicit frame prioritization, the given RPS and reference buffer size may be used to determine frame priority implicitly. If a POC number is observed more often in the reference picture lists (e.g., reference picture lists L0 and L1), the POC may earn a higher priority because the observed time may imply the opportunity of being referenced in motion estimation module 1012. For example, Table 1 shows that POC 2 in the reference picture lists L0 and L1 may be observed three times and that POC 6 may be observed five times. Implicit frame prioritization may be used to assign the higher priority to POC 6.

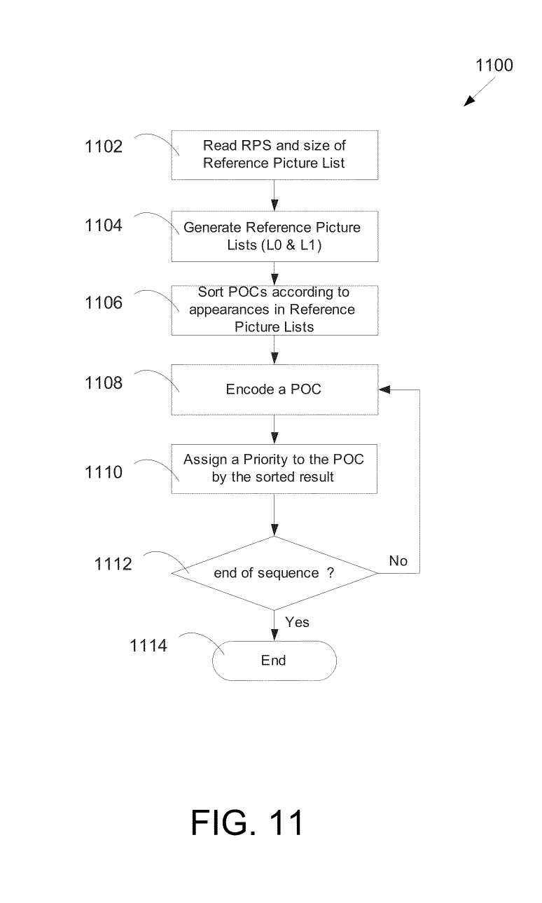

FIG. 11 is a diagram that illustrates an example method 1100 for performing implicit frame prioritization. The example method 1100 may be performed by an encoder and/or another device capable of prioritizing video frames. As shown in FIG. 11, an RPS and/or a size of a reference picture list (e.g., L0 and L1) may be read at 1102. At 1104, reference picture lists (e.g., L0 and L1) may be generated. The reference picture lists may be generated in a table for each GOP size. The frames at a given POC may be sorted at 1106. The frames may be sorted according to the number of appearances in the reference picture lists (e.g., L0 and L1). At 1108, a frame at a POC may be encoded. The frame at the POC may be assigned a priority at 1110. The assigned priority may be based on the results of the sort performed at 1106. For example, the frames with a higher number of appearances in the reference picture lists (e.g., L0 and L1) may be given a higher priority. A different priority may be assigned to frames in the same temporal level. At 1112, it may be determined whether the end of a frame sequence has been reached. The frame sequence may include an Intra Period, a GOP, or other sequence for example. If the end of the frame sequence has not been reached at 1112, the method 1100 may return to 1108 to encode a next POC and assigned a priority based on the results of the sort performed at 1106. If the end of the frame sequence has been reached at 1112, the method 1100 may end at 1114. After the end of method 1100, the priority information may be signaled to the transmission layer for being transmitted to the decoder.

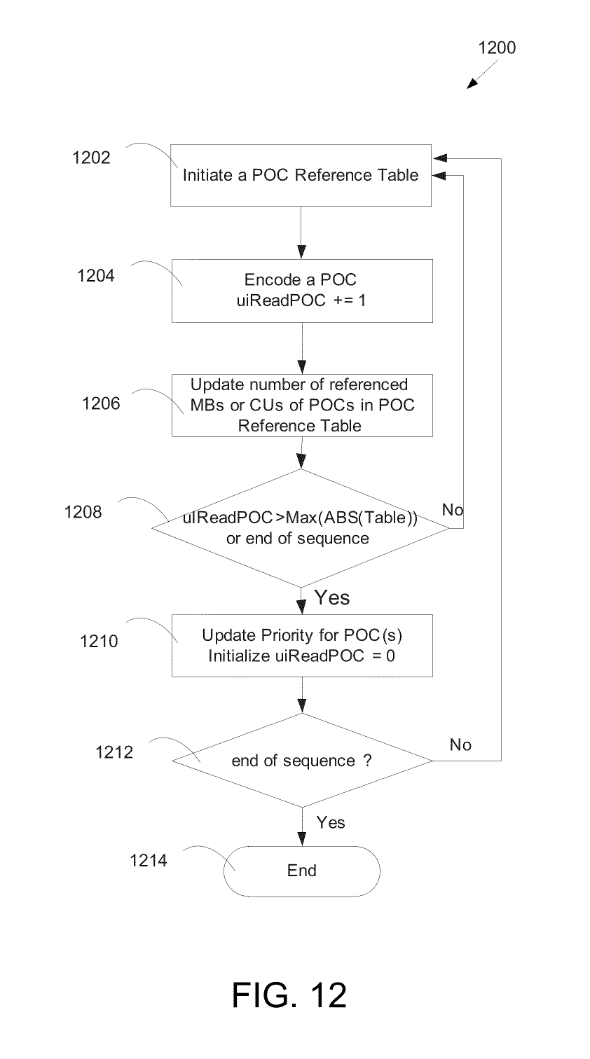

FIG. 12 is a diagram that illustrates an example method 1200 for performing explicit frame prioritization. The example method 1200 may be performed by an encoder and/or another device capable of prioritizing video frames. At 1202, a POC reference table may be initiated. A frame having a POC may be encoded and/or an internal counter uiReadPOC may be incremented when the frame is encoded at 1202. The number of the internal counter uiReadPOC may indicate the number of POCs that have been processed. The number of referenced MBs or CUs for each POC in the POC reference table may be updated at 1206. The POC table may show the MBs or CUs of a POC and the number of times they have been referenced by other POCs. For example, the table may show that POC 8 is referenced by other POCs 20 times.

At 1208, it may be determined whether the size of the counter uiReadPOC is greater than a maximum size (e.g., maximum absolute size) of the reference table. For example, the maximum size of the reference table in Table 1 may be 16. If the size of the counter uiReadPOC is less than the maximum size of the reference table, the method 1200 may return to 1202. The number of referenced MBs or CUs may be read and/or updated until the size of the counter uiReadPOC is greater than the maximum size of the POC reference table. When the size of the counter uiReadPOC is greater than the maximum size of the table (e.g., each MB or CU in the table has been read), the priority for one or more POCs may be updated. The method 1200 may be used to determine the number of times the MBs or CUs of each POC may be referenced by other POCs and may use the reference information to assign the frame prioritization. The priority for POC(s) maybe updated and/or the counter uiReadPOC may be initialized to zero at 1210. At 1212, it may be determined whether the end of a frame sequence has been reached. The frame sequence may include an Intra Period for example. If the end of the frame sequence has not been reached at 1212, the method 1200 may return to 1202 to encode the frame at the next POC. If the end of the frame sequence has been reached at 1212, the method 1200 may end at 1214. After the end of method 1200, the priority information may be signaled to the transmission layer for being transmitted to the decoder or another network entity, such as a router or gateway.

As illustrated by methods 1100 and 1200, implicit frame prioritization may derive priority by looking at the prediction structure of a frame in advance, which may cause less delay on the transmission side. If the POC includes multiple slices, the priority may be assigned to each slice of a frame based on the prediction structure. Implicit frame prioritization may be combined with other codes, such as Raptor FEC codes, to show its performance gain. In an example, Raptor FEC codes, a NAL packet loss simulator, and/or the implicit frame prioritization may be implemented.

Each frame may be encoded and/or packetized. The frames may be encoded and/or packetized within a NAL packet. Packets may be protected with selected FEC redundancy as shown in Table 4. The FEC redundancy may be applied to frames with the same priority. According to Table 4, frames with the highest priority may be protected with 44% FEC redundancy, frames with high priority may be protected with 37% FEC redundancy, frames with medium-high priority may be protected with 32% FEC redundancy, frames with medium priority may be protected with 30% FEC redundancy, frames with medium-low priority may be protected with 28% FEC redundancy, and/or frames with low priority may be protected with 24% FEC redundancy.

TABLE 4
Applied Raptor FEC Redundancies

| Prioritization Type | Priority | Redundancy |
|---|---|---|
| UEP with uniform | Highest | 44% |
| prioritization | High | 37% |
| | Medium | 30% |
| | Low | 24% |
| UEP with the implicit frame | Highest | 44% |
| prioritization | High | 37% |
| | Medium-high | 32% |
| | Medium-Low | 28% |
| | Low | 24% |

When implicit frame prioritization is combined with UEP, frames in the same temporal level may be assigned different priorities and/or receive different FEC redundancy protection. For example, when the frames in Position A and the frames in Position B are in the same temporal level, the frames in Position A may be protected with 28% FEC redundancy (e.g., medium-low priority) and/or the frames in Position B may be protected with 32% FEC redundancy (e.g., medium-high priority). When uniform prioritization is combined with UEP, frames in the same temporal level may be assigned the same priority and/or receive the same FEC redundancy protection. For example, frames at Position A and at Position B may be protected with 30% FEC redundancy (e.g., medium priority). In hierarchical B pictures with a GOP of eight and four temporal levels, frames in the lowest temporal level (e.g., POC 0 and 8) may be protected with the highest priority, frames in temporal level 1 (e.g., POC 4) may be protected with the high priority, and/or frames in the highest temporal level (e.g., POC 1, 3, 5, 7) may be protected with the lowest priority.

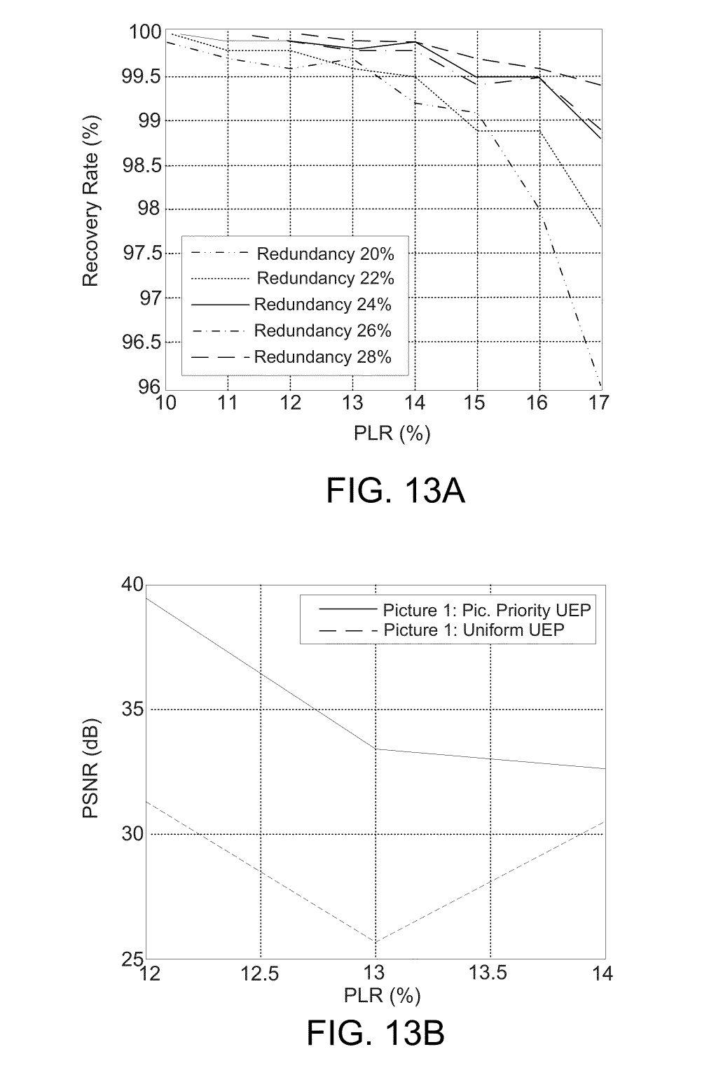

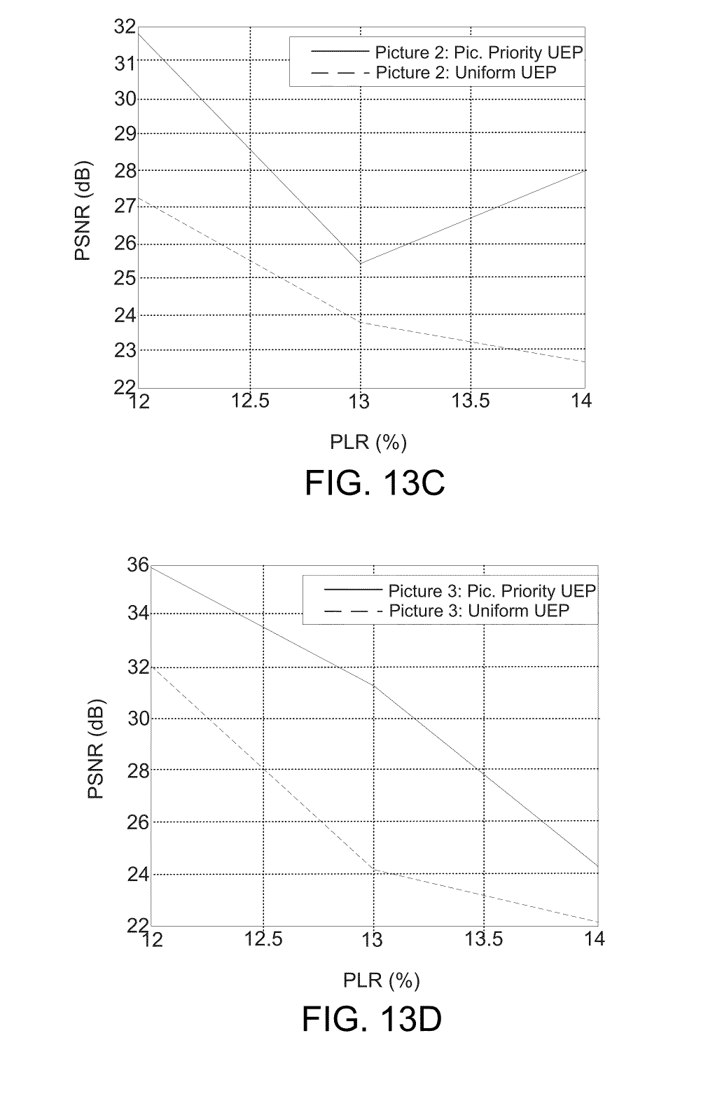

FIG. 13A is a graph that shows an average data loss recovery as a result of Raptor FEC codes in various Packet Loss Rate (PLR) conditions. The PLR conditions are illustrated on the x-axis of FIG. 13A from 10% to 17%. The Raptor FEC codes show data loss recovery rate percentage on the y-axis from 96% to 100% for various PLR conditions, for FEC redundancy (e.g., overhead) rates. For example, the Raptor FEC codes with a 20% redundancy may recover between about 99.5% and 100% of the damaged data when PLR may be less than about 13% and the data loss may accelerate toward about 96% as the PLR increases toward 17%. The Raptor FEC codes with a 22% redundancy may recover between about 99.5% and 100% of the damaged data when PLR may be less than about 14% and the data loss may accelerate toward about 97.8% as the PLR increases toward 17%. The Raptor FEC codes with a 24% redundancy may recover between about 99.5% and 100% of the damaged data when PLR may be less than about 15% and the data loss may accelerate toward about 98.8% as the PLR increases toward 17%. The Raptor FEC codes with a 26% redundancy may recover about 100% of the damaged data when PLR may be less than about 11% and the data loss may accelerate toward about 98.9% as the PLR increases toward 17%. The Raptor FEC codes with a 28% redundancy may recover about 100% of the damaged data when PLR may be less than 12% and the data loss may accelerate toward about 99.4% as the PLR increases toward 17%.

FIGS. 13B-13D are graphs that show an average PSNR of UEP tests with various frame sequences, such frame sequences in Picture 1, Picture 2, and Picture 3, respectively. The PLR conditions are illustrated on the x-axis of FIGS. 13B-13D from 12% to 14% with FEC redundancies being taken from Table 4. In FIG. 13B, the PSNR on the y-axis ranges from 25 dB to 40 dB. In FIG. 13C, the PSNR on the y-axis ranges from 22 dB to 32 dB. In FIG. 13D, the PSNR on the y-axis ranges from 22 dB to 36 dB.

In FIGS. 13B-13D, more packets were dropped as the PLR % increases from 12% to 14%. As shown in FIG. 13B, the PSNR for Picture 1 may range from about 40 dB to about 34 dB when the PLR is between 12% and 13% and picture priority UEP is used. The PSNR for Picture 1 may range from about 34 dB to about 32.5 dB when the PLR is between 13% and 14% and picture priority UEP is used. The PSNR for Picture 1 may range from about 32 dB to about 26 dB when the PLR is between 12% and 13% and uniform UEP is used. The PSNR for Picture 1 may range from about 26 dB to about 30.5 dB when the PLR is between 13% and 14% and uniform UEP is used.

As shown in FIG. 13C, the PSNR for Picture 2 may range from about 32 dB to about 25.5 dB when the PLR is between 12% and 13% and picture priority UEP is used. The PSNR for Picture 2 may range from about 25.5 dB to about 28 dB when the PLR is between 13% and 14% and picture priority UEP is used. The PSNR for Picture 2 may range from about 27 dB to about 24 dB when the PLR is between 12% and 13% and uniform UEP is used. The PSNR for Picture 2 may range from about 24 dB to about 22.5 dB when the PLR is between 13% and 14% and uniform UEP is used.

As shown in FIG. 13D, the PSNR for Picture 3 may range from about 36 dB to about 31 dB when the PLR is between 12% and 13% and picture priority UEP is used. The PSNR for Picture 3 may range from about 31 dB to about 24 dB when the PLR is between 13% and 14% and picture priority UEP is used. The PSNR for Picture 3 may range from about 32 dB to about 24 dB when the PLR is between 12% and 13% and uniform UEP is used. The PSNR for Picture 3 may range from about 24 dB to about 22 dB when the PLR is between 13% and 14% and uniform UEP is used.

The graphs in FIGS. 13B-13D show that the use of picture priority based on prediction information may result in better video quality in PSNR (e.g., from 1.5 dB to 6 dB) compared to the uniform UEP. An increased PSNR may be achieved by indicating the priority of picture frames in the same temporal level and treating those frames with higher priority to mitigate loss of the frames with a higher priority in a temporal level. As shown in FIGS. 13B and 13C, the PSNR values of PLR at 14% may be higher than the value of PLR at 13%. This may be due to the fact that packets may be dropped randomly and the PSNR may be higher at PLR 14% than PLR 13% when less important packets are dropped at PLR 14%. Other conditions, such as test sequences, encoding options, and/or EC option for NAL packet decoding, may be similar to the conditions illustrated in FIGS. 13B-13D.

The priority of a frame may be indicated in a video packet, a syntax of a video stream including a video file, and/or an external video description protocol. The priority information may indicate the priority of one or more frames. The priority information may be included in a video header. The header may include one or more bits that may be used to indicate the level of priority. If a single bit is used to indicate priority, the priority may be indicated as being high priority (e.g., indicated by a ‘1’) or low priority (e.g., indicated by a ‘0’). When more than one bit is used to indicate a level of priority, the levels of priority may be more specific and may have a broader range (e.g., low, medium-low, medium, medium-high, high, etc.). The priority information may be used to distinguish the level of priority of frames in different temporal levels and/or the same temporal level. The header may include a flag that may indicate whether the priority information is being provided. The flag may indicate whether a priority identifier is provided to indicate the priority level.

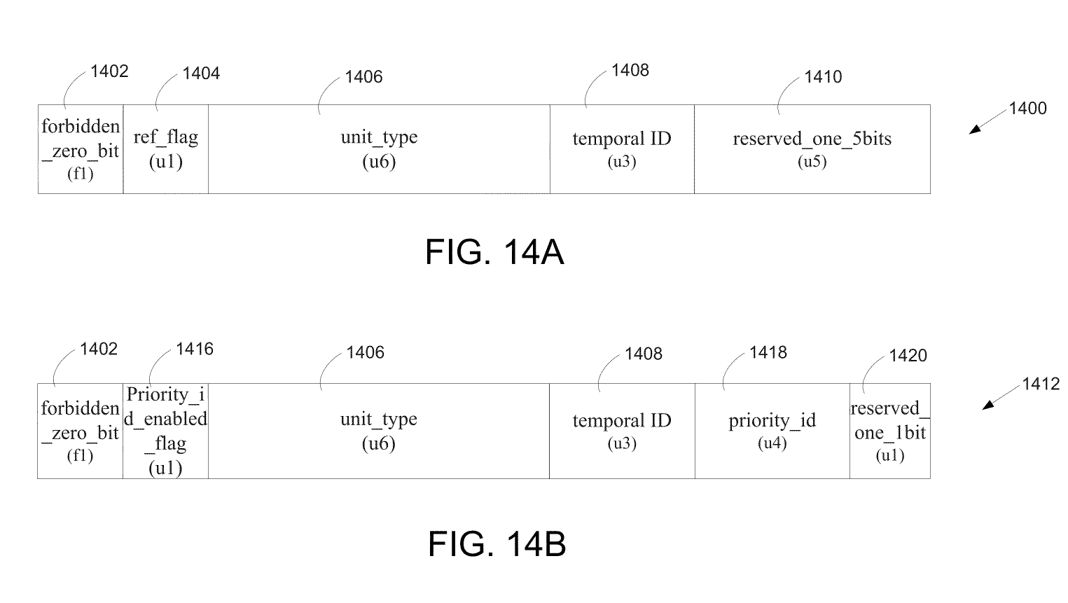

FIGS. 14A and 14B are diagrams that provide examples of headers 1400 and 1412 that may be used to provide video information for a video packet. The headers 1400 and/or 1412 may be Network Abstraction Layer (NAL) headers and the video frame may be included in a NAL unit, such as when H.264/AVC or HEVC are implemented. The headers 1400 and 1412 may each include a forbidden_zero_bit field 1402, a unit_type field 1406 (e.g., a nal_unit_type field when a NAL header is used), and/or a temporal_id field 1408. Some video formats (e.g., HEVC) may use the forbidden_zero_bit field 1402 to determine that there has been a syntax violation in the NAL unit (e.g., when the value is set to ‘1’). The unit_type field 1406 may include one or more bits (e.g., a six-bit field) that may indicate the type of data in the video packet. The unit_type field 1406 may be a nal_unit_type field that may indicate the type of data in a NAL unit.

The temporal_id field 1408 may include one or more bits (e.g., a three-bit field) that may indicate the temporal level of one or more frames in the video packet. For Instantaneous Decoder refresh (IDR) pictures, Clean Random Access (CRA) pictures, and/or I-frames, the temporal_id field 1408 may include a value equal to zero. For temporal level access (TLA) pictures and/or predictively coded pictures (e.g., B-frames or P-frames), the temporal_id field 1408 may include a value greater than zero. The priority information may be different for each value in the temporal_id field 1408. The priority information may be different for frames having the same value in the temporal_id field 1408 to indicate a different level of priority for frames within the same temporal level.

Referring to FIG. 14A, the header 1400 may include a ref flag field 1404 and/or a reserved_one_{—}5 bits field 1410. The reserved_one_{—}5 bits field 1410 may include reserved bits for future extension. The ref_flag 1404 may indicate whether the frame(s) in the NAL unit are referenced by the other frame(s). The ref_flag field 1404 may be a nal_ref_flag field when in a NAL header. The ref_flag field 1404 may include a bit or value that may indicate whether the content of the video packet may be used to reconstruct reference pictures for future prediction. A value (e.g., ‘0’) in the ref_flag field 1404 may indicate that the content of the video packet is not used to reconstruct reference pictures for future prediction. Such video packets may be discarded without potentially damaging the integrity of the reference pictures. A value of (e.g., ‘1’) in the ref_flag field 1404 may indicate that the video packet may be decoded to maintain the integrity of reference pictures or that the video packet may include a parameter set.

Referring to FIG. 14B, the header 1412 may include a flag that may indicate whether the priority information is enabled. For example, the header 1412 may include a priority_id_enabled_flag field 1416 that may include a bit or value that may indicate whether the priority identifier is provided for the NAL unit. The priority_id_enabled_flag field 1416 may be a nal_priority_id_enabled_flag field when in a NAL header. The priority_id_enabled_flag field 1416 may include a value (e.g., ‘0’) that may indicate that the priority identifier is not provided. The priority_id_enabled_flag field 1416 may include a value (e.g., ‘1’) that may indicate that the priority identifier is provided. The priority_id_enabled_flag 1416 may be placed in the location of the ref_flag 1404 of the header 1400. The priority_id_enabled_flag 1416 may be used in the place of the ref_flag 1404 because the role of ref_flag 1404 may overlap with the priority_id field 1418.

The header 1412 may include a priority_id field 1418 for indicating the priority identifier of the video packet. The priority_id field 1418 may be indicated in one or more bits of the reserved_one_{—}5 bits field 1410. The priority_id field 1418 may use four bits and leave a reservedone_{—}1bit field 1420. For example, the priority_id field 1418 may indicate a highest priority using a series of bits 0000 and may set the lowest priority to 1111. When the priority_id field 1418 uses four bits, it may provide 16 levels of priory. If the priority_id field 1418 is used with the temporal_id field 1408, the temporal_id field 1408 and the priority_id field 1418 may provide 2′7 (=128) levels of priority. Any other number of bits may be used to provide different levels of priority. The reserved_one_{—}1bit field may be used for an extension flag, such as a nal_extension_flag for example. The priority_id field 1418 may indicate a level of priority for one or more video frames in a video packet. The priority level may be indicated for video frames having the same or different temporal levels. For example, the priority_id field 1418 may be used to indicate a different level of priority for video frames within the same temporal level.

Table 5 shows an example for implementing a NAL unit using a priority_id_enabled_flag and a priority_id.

TABLE 5
Example NAL Unit that may Implement a Priority ID

| nal_unit( NumBytesInNALunit ) { | Descriptor |
|---|---|
| forbidden_zero_bit | f(1) |
| nal_priority_id_enabled_flag | u(1) |
| nal_unit_type | u(6) |
| NumBytesInRBSP = 0 | |
| temporal_id | u(3) |
| if (nal_priority_id_enabled_flag) { | |
| priority_id | u(4) |
| reserved_one_1bit | u(1) |
| } else { | |
| reserved_one_5bits | u(5) |
| } | |
| . . . | . . . |
| } | |

As shown in Table 5, a header may include a forbidden_zero_bit field, a nal_priority_id_enabledflag field, a nal_unit_type field, and/or a temporal_id field. If the nal_priority_id_enabled_flag field indicates that the priority identification is enabled (e.g., nal_priority_id_enabledflag field=1), the header may include the priority_id field and/or the reservedone_{—}1bit field. The priority_id field may indicate a level of priority of one or more video frames associated with the NAL unit. For example, the priority_id field may distinguish between video frames on different temporal levels and/or the same temporal level of a hierarchical structure. If the nal_priority_id_enabled_flag field indicates that the priority identification is disabled (e.g., nal_priority_id_enabled_flag field=0), the header may include the reserved_one_{—}5 bit field. While Table 5 may illustrate an example NAL unit, similar fields may be used to indicate priority in another type of data packet.

Fields in Table 5 may have a descriptor f(n) or u(n). The descriptor f(n) may indicate a fixed-pattern bit string using n bits. The bit string may be written from left to right with the left bit first. The parsing process for f(n) may be specified by a return value of the function read_bits(n). The descriptor u(n) may indicate an unsigned integer using n bits. When n is “v” in the syntax table, the number of bits may vary in a manner dependent on the value of other syntax elements. The parsing process for u(n) descriptor is specified by the return value of the function read_bits(n) interpreted as a binary representation of an unsigned integer with most significant bit written first.

The header may initialize the number of bytes in the raw byte sequence payload (RBSP). The RBSP may be a syntax structure that may include an integer number of bytes that may be encapsulated in a data packet. An RBSP may be empty or may have the form of a string of data bits that may include syntax elements followed by an RBSP stop bit. The RBSP may be followed by zero or more subsequent bits that may be equal to zero.

When the frames have different temporal levels, the frames in lower temporal level may have a higher priority than the frames in higher temporal level. Frames in the same temporal level may be distinguished from each other based on their priority level. The frames within the same temporal level may be distinguished using a header field that may indicate whether a frame has a higher or lower priority than other frames in same temporal level. The priority level may be indicated using a priority identifier for a frame, or by indicating a relative level of priority. The relative priority of frames within the same temporal level within a GOP may be indicated using a one-bit index. The one bit index may be used to indicate a relatively higher and/or lower level of priority for frames within the same temporal level. Referring back to FIG. 6 as an example, if frame 606 is determined to have a higher priority than frame 602 in same temporal level 614, frame 606 may be allocated value indicating that frame 606 has a higher priority (e.g., ‘1’) and/or frame 602 may be allocated a value indicating that frame 602 has a lower priority (e.g., ‘0’).

The header may be used to indicate the relative priority between frames in the same temporal level. A field that indicates a relatively higher or lower priority than another frame in the same temporal level may be referred to as a priority_idc field. If the header is a NAL header, the priority_idc field may be referred to as a nal priority_idc field. The priority_idc field may use a 1-bit index. The priority_idc field may be located in the same location as the ref_flag field 1404 and/or the priority_id_enabled_flag field 1416 illustrated in FIGS. 14A and 14B. The location of the priority_idc field 1404 may be another location in the header, such as after the temporal_id field 1408 for example.

Table 6 shows an example for implementing a NAL unit with the priority_idc field.

TABLE 6
Example NAL Unit that may Implement a Priority IDC Field

| nal_unit( NumBytesInNALunit ) { | Descriptor |
|---|---|
| forbidden_zero_bit | f(1) |
| nal_priority_idc | u(1) |
| nal_unit_type | u(6) |
| NumBytesInRBSP = 0 | |
| temporal_id | u(3) |
| reserved_one_5bits | u(5) |
| . . . | |
| } | |

Table 6 includes similar information to the Table 5 illustrated herein. As shown in Table 6, a header may include a forbidden_zero_bit field, a nal_priority_idc field, a nal_unit_type field, a temporal_id field, and/or a reserved_one_{—}5 bits field. While Table 6 may illustrate an example NAL unit, similar fields may be used to indicate priority in another type of data packet.

The priority information may be provided using a supplemental enhancement information (SEI) message. An SEI message may assist in processes related to decoding, display, or other processes. Some SEI may include data, such as picture timing information, which may precede the primary coded frame. The frame priority may be included in an SEI message as shown in Table 7 and/or Table 8.

TABLE 7
SEI payload

| sei_payload( payloadType, payloadSize ) | Descriptor |
|---|---|
| { | |
| if( payloadType = = 0 ) | |
| buffering_period( payloadSize ) | |
| ........... | |
| else if( payloadType = = type ID) | |
| priority_info( payloadSize ) | |
| ........... | |

As shown in Table 7, the payload of the SEI may include a payload type and/or a payload size. The priority information may be set to the payload size of the SEI payload. For example, if the payload type is equal to a predetermined type ID, the priority information may be set to the payload size of the SEI payload. The predetermined type ID may include a predetermined value (e.g., 131) for setting the priority information.

TABLE 8
Definition of a priority_info for SEI.

| priority_info (payloadSize ) { | Descriptor |
|---|---|
| priority_id | u(4) |
| Reserved | u(4) |
| } | |

As shown in Table 8, the priority information may include a priority identifier that may be used to indicate the priority level. The priority identifier may include one or more bits (e.g., 4 bits) that may be included in the SEI payload. The priority identifier may be used to distinguish the priority level between frames within the same temporal level and/or different temporal levels. The bits in the priority info that are unused to indicate the priority identifier may be reserved for other use.

The priority information may be provided in an Access Unit (AU) delimiter. The decoding of each AU may result in a decoded picture. Each AU may include a set of NAL units that together may compose a primary coded frame. It may also be prefixed with an AU delimiter to aid in locating the start of the AU.

Table 9 shows an example for providing the priority information in an AU delimiter.

TABLE 9
Define a priority_id in AU delimiter

| access_unit_delimiter_rbsp( ) { | Descriptor |
|---|---|
| pic_type | u(3) |
| priority_id | u(4) |
| rbsp_trailing_bits( ) | |
| } | |

As shown in Table 9, the AU delimiter may include a picture type, a priority identifier, and/or RBSP trailing bits. The picture type may indicate the type of picture following the AU delimiter, such as an I-picture/slice, a P-picture/slice, and/or a B-picture/slice. The RBSP trailing bits may fill the end of payload with zero bits to align the byte. The priority identifier may be used to indicate the priority level of one or more frames having the indicated picture type. The priority identifier may be indicated using one or more bits (e.g., 4 bits). The priority identifier may be used to distinguish the priority level between frames within the same temporal level and/or different temporal levels.

While the fields described herein may be provided for a NAL syntax and/or the HEVC, similar fields may be implemented for other video types. For example, Table 10 illustrates an example of an MPEG Media Transport (MMT) packet that includes a priority field.

TABLE 10
MMT Transport Packet

| | No. | |
|---|---|---|
| Syntax | of bits | Mnemonic |
| MMT_packet ( ){ | | |
| sequence number | | uimsbf |
| Timestamp | | uimsbf |
| RAP_flag | 1 | uimsbf |
| header_extension_flag | 1 | uimsbf |
| padding_flag | 1 | uimsbf |
| service_classifier ( ) { | | |
| service_type | 4 | bslbf |
| type_of_bitrate | 3 | bslbf |
| Throughput | 1 | bslbf |
| } | | |
| QoS_classifier ( ) { | | |
| delay_sensitivity | 3 | bslbf |
| reliability_flag | 1 | bslbf |
| loss_priority | 3 | bslbf |
| Reserved | 1 | bslbf |
| } | | |
| flow_identifier ( ) { | | |
| flow_label | 7 | bslbf |
| extension_flag | 1 | bslbf |
| } | | |
| T.B.D. | | |
| If (header_extension_flag ==’1’) | | |
| { | | |
| MMT_packet_extension_header( ) | | |
| } | | |
| MMT_payload ( ) | | |
| } | | |

An MMT packet may include a digital container that may support HEVC video. Because the MMT includes the video packet syntax and file format for transmission, the MMT packet may include a priority field. The priority field in Table 10 is labeled loss_priority. The loss_priority field may include one or more bits (e.g., three bits) and may be included in the QoS classifier( ). The loss_priority field may be a bit string with the left bit being the first bit in the bit string, which may be indicated by the mnemonic bslbf for “Bit String, Left Bit First.” The MMT packet may include other functions, such as a service classifier( ) and/or a flow identifier( ) that may include one or more fields that may each include one or more bits that are bslbf. The MMT packet may be also include a sequence number, a time stamp, a RAP flag, a header extension flag, and/or a padding flag. These fields may each include one or more bits that may be an unsigned integer having the most significant bit first, which may be indicated by the mnemonic uimsbf for “Unsigned Integer Most Significant Bit First.”

Table 11 provides an example description of the loss_priority field in the MPEG Media Transport (MMT) packet illustrated in Table 10.

TABLE 11
Example of loss_priority field in a MMT Transport Packet
Loss_priority

(3-bits): (This field may be mapped to the NRI of NAL, DSCP of IETF, or
other loss priority field in another network protocol)

As shown in Table 11, the loss_priority field may indicate a level of priority using a bit sequence (e.g., three bits). The loss_priority field may use consecutive values in the bit sequence to indicate different levels of priority. The loss_priority field may be used to indicate a level of priority between and/or amongst different types of data (e.g., audio, video, text, etc.). The loss_priority field may indicate different levels of priority for different types of video data (e.g., I-frames, P-frames, B-frames). When the video data is provided in different temporal levels, the loss priority field may be used to indicate different levels of priority for video frames within the same temporal level.

The loss_priority field may be mapped to a priority field in another protocol. The MMT may be implemented for transmission and the transport packet syntax may carry various types of data. The mapping may be for compatibility purposes with other protocols. For example, the loss_priority field may be mapped to a NAL Reference Index (NRI) of NAL and/or a Differentiated Services Code Point (DSCP) of IETF. The loss_priority field may be mapped to a temporal_id field of NAL. The loss_priority field in the MMT Transport Packet may provide an indication or explanation regarding how the field may be mapped to the other protocols. The priority_id field described herein (e.g., for HEVC) may be implemented in a similar manner to or have a connection with the loss_priority field of the MMT Transport Packet. The priority_id field may be directly mapped to the loss_priority field, such as when the number of bits for each field are the same. If the number of bits of the priority_id field and the loss_priority field are different, the syntax that has a greater number of bits may be quantized to the syntax having a lower number of bits. For example, if the priority_id field includes four bits, the priority_id field may be divided by two and may be mapped to a three-bit loss_priority field. The frame priority information may be implemented by other video types. For example, MPEG-H MMT may implement a similar form of frame prioritization as described herein.

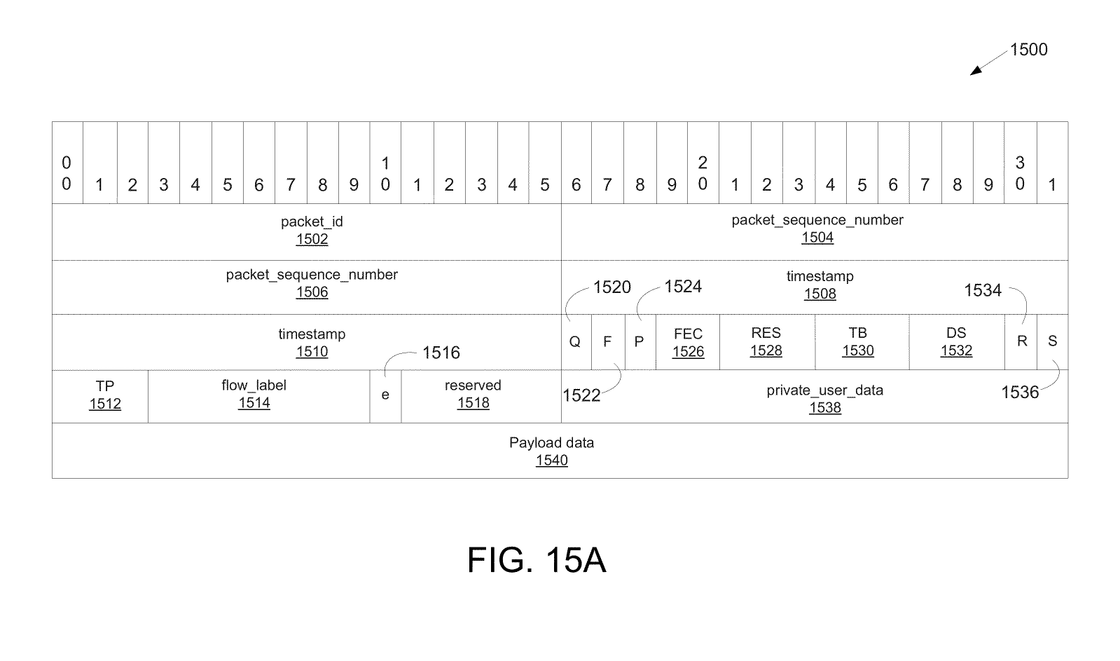

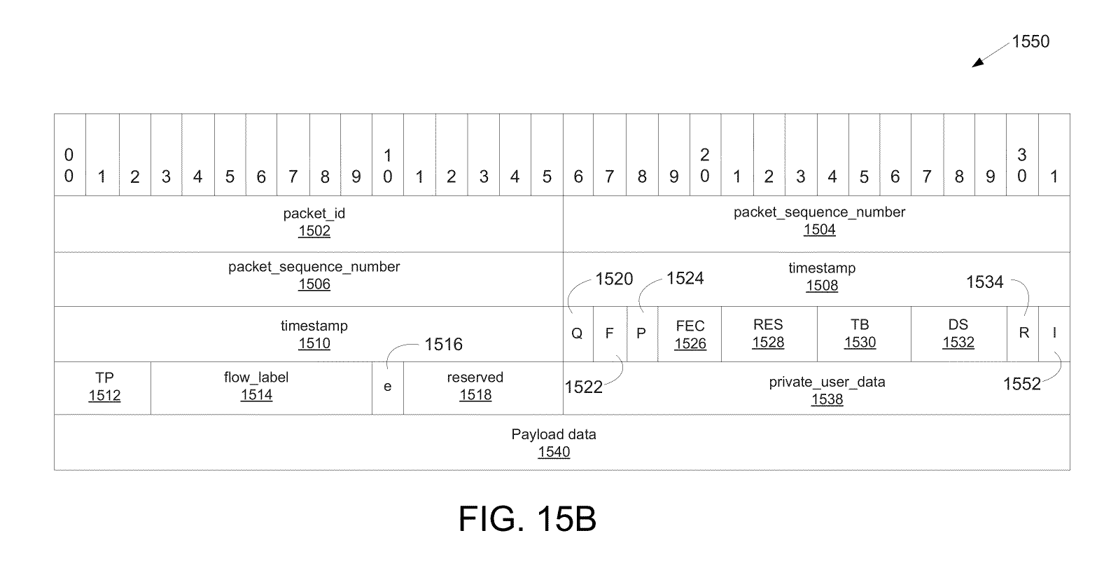

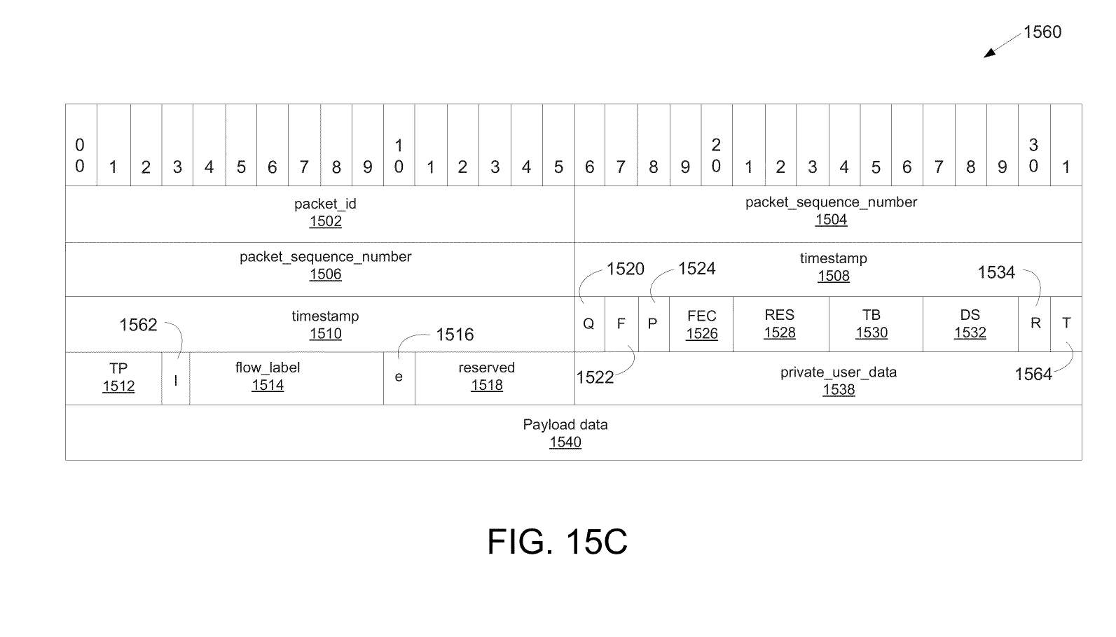

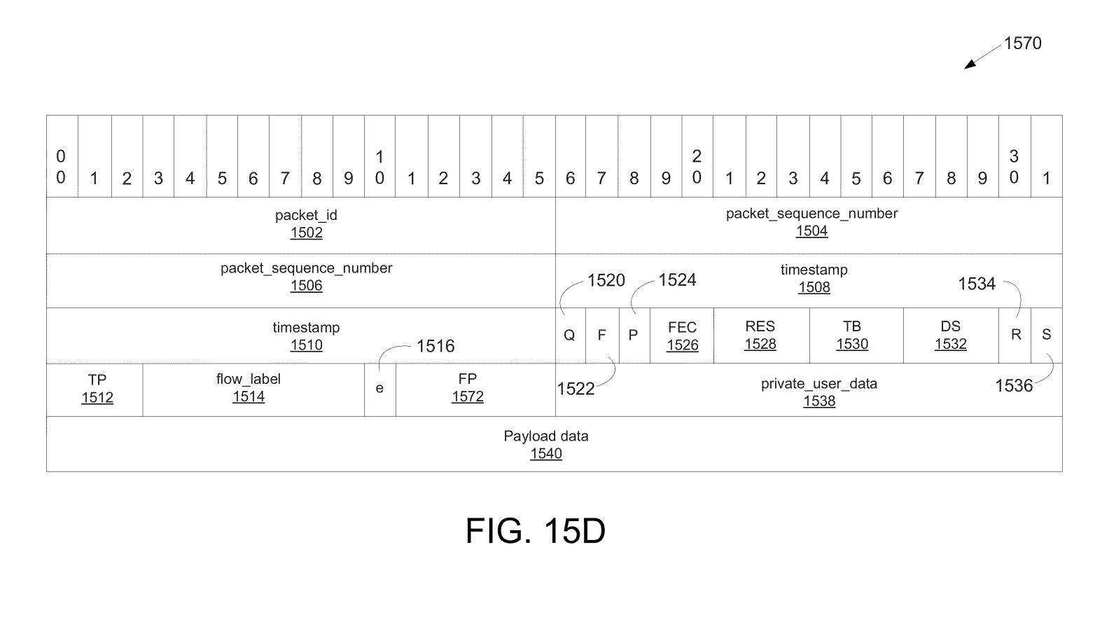

FIG. 15A illustrates an example packet header for a packet 1500 that may be used to implement frame prioritization. The packet 1500 may be an MMT transport packet and the header may be an MMT packet header. The header may include a packet ID 1502. The packet ID 1502 may be an identifier of the packet 1500. The packet ID 1502 may be used to indicate the media type of data included in the payload data 1540.

The header may include a packet sequence number 1504, 1506 and/or a timestamp 1508, 1510 for each packet in the sequence. The packet sequence number 1504, 1506 may be an identification number of a corresponding packet. The timestamps 1508 and 1510 may correspond to a transmission time of the packet having the respective packet sequence numbers 1504 and 1506.

The header may include a flow identifier flag (F) 1522. The F 1522 may indicate the flow identifier. The F 1522 may include one or more bits that may indicate (e.g., when set to ‘1’) that flow identifier information is implemented. Flow identifier information may include a flow label 1514 and/or an extension flag (e) 1516, which may be included in the header. The flow label 1514 may identify a quality of service (QoS) (e.g., a delay, a throughput, etc.) that may be used for each flow in each data transmission. The e 1516 may include one or more bits for indicating an extension. When there are more than a predefined number of flows (e.g., 127 flows), the e 1516 may indicate (e.g., by being set to ‘1’) that one or more bytes may be used for extension. Per-flow QoS operations may be performed in which network resources may be temporarily reserved during the session. A flow may be a bitsream or a group of bitstreams that have network resources that may be reserved according to transport characteristics or ADC in a package.

The header may include a private user data flag (P) 1524, a forward error correction type (FEC) field 1526, and/or reserved bits (RES) 1528. The P 1524 may include one or more bits that may indicate (e.g., when set to ‘1’) that private user data information is implemented. The FEC field 1526 may include one or more bits (e.g., 2 bits) that may indicate an FEC related type information of an MMT packet. The RES 1528 may be reserved for other use.

The header may include a type of bitrate (TB) 1530, reserved bits 1518 (e.g., a 5-bit field) and/or a reserved bit (S) 1536 that may be reserved for other use, private user data 1538, and/or payload data 1540. The TB 1530 may include one or more bits (e.g., 3 bits) that may indicate the type of bitrate. The type of bitrate may include a constant bitrate (CBR, a non-CBR, or the like.

The header may include a QoS classifier flag (Q) 1520. The Q 1520 may include one or more bits that may indicate (e.g., when set to ‘1’) that QoS classifier information is implemented. A QoS classifier may include a delay sensitivity (DS) field 1532, a reliability flag (R) 1534, and/or a transmission priority (TP) field 1512, which may be included in the header. The delay sensitivity field may indicate the delay sensitivity of the data for a service. An example description of the R 1534 and the transmit priority field 1512 are provided in Table 12. The Q 1520 may indicate the QoS class property. Per-class QoS operations may be performed according to the value of a property. The class values may be universal to each independent session.

Table 12 provides an example description of the reliability flag 1534 and the TP field 1512.

TABLE 12
Transmission priority field in a packet header

reliability_flag (R: 1 bit) - When reliability_flag may be set to ‘0’, it may
indicate that the data may be loss tolerant (e.g., media data), and that the
following 3-bits may be used to indicate relative priority of loss.
When reliability_flag may be set to 1, the transmission_priority field
may be ignored, and may indicate that the data may be not loss tolerant
(e.g., signaling data, service data, or program data).
transmission_priority (TP: 3 bits) - This field provides the
transmission_priority for the media packet, and it may be mapped to
the NRI of NAL, DSCP of IETF, or other loss priority field in another
network protocol. This field may take values from ‘7’ (‘1112’) to
‘0’ (‘0002’), where 7 may be the highest priority, and ‘0’ may be the
lowest priority.

As shown in Table 12, the reliability flag 1534 may include a bit that may be set to indicate that the data (e.g., media data) in the packet 1500 is loss tolerant. For example, the reliability flag 1534 may indicate that one or more frames in the packet 1500 are loss tolerant. For example, the packets may be dropped without severe quality degradation. The reliability flag 1534 may indicate that the data (e.g., signaling data, service data, programing data, etc.) in the packet 1500 is not loss tolerant. The reliability flag 1534 may be followed by one or more bits (e.g., 3 bits) that may indicate a priority of the lost frames.

The reliability flag 1534 may indicate whether to use the priority information in the TP 1512 or to ignore the priority information in the TP 1512. The TP 1512 may be a priority field of one or more bits (e.g., 3-bit) that may indicate the priority level of the packet 1500. The TP 1512 may use consecutive values in a bit sequence to indicate different levels of priority. In the example shown in Table 12, the TP 1512 uses values from zero (e.g., 0002) to seven (e.g., 1112) to indicate different levels of priority. The value of seven may be the highest priority level and the value of zero may be the lowest priority value. While the values from zero to seven are used in Table 12, any number of bits and/or range of values may be used to indicate different levels of priority.

The TP 1512 may be mapped to a priority field in another protocol. For example, the TP 1512 may be mapped to an NRI of NAL or a DSCP of IETF. The TP 1512 may be mapped to a temporal_id field of NAL. The TP 1512 in the packet 1500 may provide an indication or explanation regarding how the field may be mapped to the other protocols. While the TP 1512 shown in Table 12 indicates that the TP 1512 may be mapped to the NRI of NAL, which may be included in H.264/AVC, the priority mapping scheme may be provided and/or used to support mapping to HEVC or any other video coding type.

The priority information described herein, such as the nal_priority_idc, may map to the corresponding packet header field so that the packet header may provide more detailed frame priority information. When H.264 AVC is used, this priority information TP 1512 may be mapped to the NRI value (e.g., 2-bit nal ref idc) in the NAL unit header. When HEVC is used, this priority information TP 1512 may be mapped to the temporalID value (e.g., nuh_temporal_id_plus1−1) in the NAL unit header.

In H.264 or HEVC, a majority of the frames may be B-frames. The temporal level information may be signaled in the packet header to distinguish frame priorities for the same B-frames in a hierarchical B structure. The temporal level may be mapped to the temporal ID, which may be in the NAL unit header, or derived from the coding structure if possible. Examples are provided herein for signaling the priority information to a packet header, such as the MMT packet header.

FIG. 15B illustrates an example packet header for a packet 1550 that may be used to implement frame prioritization. The packet 1550 may be an MMT transport packet and the header may be an MMT packet header. The packet header of packet 1550 may be similar to the packet header of the packet 1500. In the packet 1550, the TP 1512 may be specified to indicate the temporal level of a frame that may be carried in the packet 1550. The header of packet 1550 may include a priority identifier field (I) 1552 that may distinguish priority of the frames within the same temporal level. The priority identifier field 1552 may be a nal_priority_idc field. The priority level in the priority identifier field 1552 may be indicated in a one-bit field (e.g., 0 for a frame that is less important and 1 for a frame that is more important). The priority identifier field 1552 may occupy the same location in the header of the packet 1550 as the reserved bit 1536 of the packet 1500.

FIG. 15C illustrates an example packet header for a packet 1560 that may be used to implement frame prioritization. The packet 1560 may be an MMT transport packet and the header may be an MMT packet header. The packet header of packet 1560 may be similar to the packet header of the packet 1500. The header of packet 1560 may include a priority identifier field (I) 1562 and/or a frame priority flag (T) 1564. The priority identifier field 1562 may distinguish priority of the frames within the same temporal level. The priority identifier field 1562 may be a nal_priority_idc field. The priority level in the priority identifier field 1552 may be indicated with a single bit (e.g., 0 for a frame that is less important and 1 for a frame that is more important). The priority identifier field 1552 may be signaled following the TP 1512. The TP 1512 may be mapped to the temporal level of the frame carried in the packet 1560.

The frame priority flag 1564 may indicate whether the priority identifier field 1562 is being signaled. For example, the frame priority flag 1564 may be a one-bit field that may be switched to indicate whether the priority identifier field 1562 is being signaled or not (e.g., the frame priority flag 1564 may be set to ‘1’ to indicate that the priority identifier field 1562 is being signaled and may be set to ‘0’ to indicate that the priority identifier field 1562 is not being signaled). When a frame_priority_flag 1564 indicates that the priority identifier field 1562 is not being signaled, the TP field 1512 and/or the flow label 1514 may be formatted as shown in FIG. 15A. The frame priority flag 1564 may occupy the same location in the header of the packet 1560 as the reserved bit 1536 of the packet 1500.

FIG. 15D illustrates an example packet header for a packet 1570 that may be used to implement frame prioritization. The packet 1570 may be an MMT transport packet and the header may be an MMT packet header. The packet header of packet 1570 may be similar to the packet header of the packet 1500. The header of packet 1570 may include a frame priority (FP) field 1572. The FP field 1572 may indicate a temporal level and/or a priority identifier for the frame(s) of the packet 1570. The FP field 1572 may occupy the same location in the header of the packet 1560 as the reserved bits 1518 of the packet 1500. The FP field 1572 may be a five-bit field. The FP field 1572 may include a three-bit temporal level and/or a two-bit priority identifier. The priority identifier may be a nal_priority_idc field. The priority identifier may distinguish the priority of the frames within the same temporal level. The priority of the frames may increase as the value of the priority identifier increases (e.g., 00₍₂₎ may be used to indicate the most important frames and/or 11₍₂₎ may be used to indicate the least important frames). While examples herein may use a two-bit priority identifier, the size of bits for the priority identifier may vary according to the video Codecs and/or transmission protocols.

The temporal_id in the MMT format may be mapped to the temporalID of NAL. The temporal_id in the MMT format may be included in a multi-layer information function (e.g., multiLayerInfo( )). The priority_id in MMT may be a priority identifier of the Media Fragment Unit (MFU). The priority_id may specify the video frame priority within the same temporal level. A Media Processing Unit (MPU) may include media data which may be independently and/or completely processed by an MMT entity and maybe consumed by the media codec layer. The MFU may indicate the format identifying fragmentation boundaries of a Media Processing Unit (MPU) payload to allow the MMT sending entity to perform fragmentation of MPU considering consumption by the media codec layer.

The temporal level field may be derived from the temporal ID of the header (e.g., 3-bit) of the frame carried in the MMT packet (e.g., the temporal ID of HEVC NAL header) or derived from the coding structure. The priority_idc may be derived from the supplementary information generated from the video encoder, streaming server, or the protocols and signals developed for the MANE. The priority_id and/or priority_idc may be used for the priority field of an MMT hint track and UEP of the MMT application level FEC as well.

An MMT package may be specified to carry complexity information of a current video bitstream as supplemental information. For example, a DCI table of an MMT may define the video_codec_complexity fields that may include video_average_bitrate, video_maximum_bitrate, horizontal_resolution, vertical_resolution, temporal_resolution, and/or video_minimum_buffer_size. Such video_codec_complexity fields may not be accurate and/or enough to present the video codec characteristics. This may be because different standard video coding bitstreams with the same resolution and/or bitrate may have different complexities. Parameters, such as video codec type, profile, level (e.g., which may be derived from embedded video packets or from the video encoder) may be added into the video_codec_complexity field. A decoding complexity level may be included in the video_codec_complexity fields to provide decoding complexity information.

Priority information may be implemented in 3GPP. For example, frame prioritization may apply to a 3GPP Codec. In 3GPP, rules may be provided for derivation of the authorized Universal Mobile Telecommunications System (UMTS) QoS parameters per Packet Data Protocol (PDP) context from authorized IP QoS parameters in a Packet Data Network-Gateway (P-GW). The traffic handling priority that may be used in 3GPP may be decided by QCI values. The priority may be derived from the priority information of MMT. The example priority information described herein may be used for the UEP described in 3GPP that may provide the detailed information of SVC-based UEP technology. As shown in FIGS. 13B-D, UEP may be combined with frame prioritization to achieve better video quality in PSNR (e.g., from 1.5 dB to 6 dB) compared to uniform UEP. As such, the frame prioritization for UEP may be applied to 3GPP or other protocols.

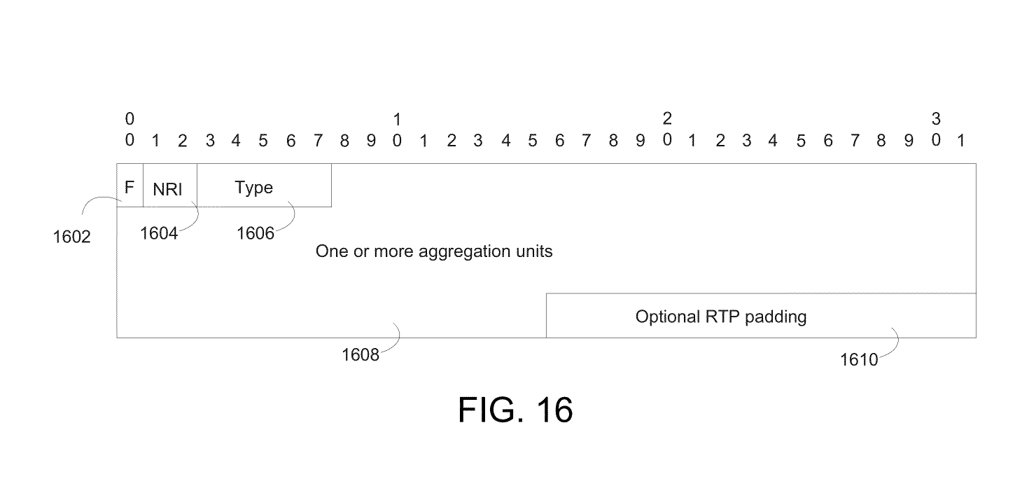

An IETF RTP Payload Format may implement frame prioritization as described herein. FIG. 16 is a diagram that depicts an example RTP payload format for aggregation packets in IETF. As shown in the FIG. 16, the example of an RTP payload format for HEVC of IETF may have a forbidden zero bit (F) field 1602, a NAL reference idc (NRI) field 1604, a type field 1606 (e.g., a five-bit field), one or more aggregation units 1608, and/or an optional RTP padding field 1610. The F field 1602 may include one or more bits that may indicate (e.g., with a value of ‘1’) that a syntax violation has occurred. The NRI field 1604 may include one or more bits that may indicate (e.g., with a value of ‘00’) that the content of a NAL unit may not be used to reconstruct reference pictures for inter picture prediction. Such NAL units may be discarded without risking the integrity of the reference pictures. The NRI field 1604 may include one or more bits that may indicate (e.g., with a value greater than ‘00’) to decode the NAL unit to maintain the integrity of the reference pictures. The NAL unit type field 1606 may include one or more bits (e.g., in a five-bit field) that may indicate the NAL unit payload type.

The IETF may indicate that the value of the NRI field 1604 may be the maximum of the NAL units carried in the aggregation packet. As such, the NRI field of the RTP payload may be used in a similar manner as the priority_id field described herein. To implement a four-bit priority_id in a two-bit NRI field, the value of the four-bit priority_id may be divided by four to be assigned to the two-bit NRI field. Additionally, the NRI field may be occupied by a temporal ID of the HEVC NAL header, which may be able to distinguish the frame priority. The priority_id may be signaled in the RTP payload format for the MANE when such priority information may be derived.

The examples described herein may be implemented at an encoder and/or a decoder. For example, a video packet, including the headers, may be created and/or encoded at an encoder for transmission to a decoder for decoding, reading, and/or executing instructions based on the information in the video packet. Although features and elements are described above in particular combinations, each feature or element may be used alone or in any combination with the other features and elements. The methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for indicating a level of priority for video frames associated with a same temporal level in a hierarchical structure, the method comprising:
identifying a plurality of video frames that are associated with the same temporal level in the hierarchical structure;
determining a priority level for a video frame in the plurality of video frames that is different than a priority level for another video frame in the plurality of video frames associated with the same temporal level in the hierarchical structure; and
signaling the priority level for the video frame.

2. The method of claim 1, wherein the priority level for the video frame is based on a number of video frames that reference the video frame.

3. The method of claim 1, wherein the priority level for the video frame is a relative priority level that indicates a relative level of priority compared to the priority level for the other video frame in the plurality of video frames associated with the same temporal level.

4. The method of claim 3, wherein the priority level is indicated using a one-bit index.

5. The method of claim 1, wherein the priority level for the video frame is indicated using a priority identifier, and wherein the priority identifier includes a plurality of bits that indicates a different level of priority using a different bit sequence.

6. The method of claim 1, wherein the priority level for the video frame is indicated in a video header or a signaling protocol.

7. The method of claim 6, wherein the video frame is associated with a Network Abstraction Layer (NAL) unit, and wherein the video header is a NAL header.

8. The method of claim 6, wherein the signaling protocol is indicated using a supplemental enhancement information (SEI) message, an MPEG media transport (MMT) protocol, or an access unit (AU) delimiter.

9. The method of claim 1, wherein the priority level of the video frame is determined explicitly based on a number of referenced macro blocks or coding units in the video frame.

10. The method of claim 1, wherein the priority level of the video frame is determined implicitly based on at least one of a reference picture set (RPS) or a reference picture list (RPL) size associated with the video frame.

11. An encoding device for indicating a level of priority for video frames associated with a same temporal level in a hierarchical structure, the encoding device comprising:
a processor configured to:
identify a plurality of video frames that are associated with the same temporal level in the hierarchical structure;
determine a priority level for a video frame in the plurality of video frames that is different than a priority level for another video frame in the plurality of video frames associated with the same temporal level in the hierarchical structure; and
signal the priority level for the video frame.

12. The encoding device of claim 11, wherein the priority level for the video frame is based on a number of video frames that reference the video frame.

13. The encoding device of claim 11, wherein the priority level for the video frame is a relative priority level that indicates a relative level of priority compared to the priority level for the other video frame in the plurality of video frames associated with the same temporal level.

14. The encoding device of claim 13, wherein the processor is configured to indicate the priority level using a one-bit index.

15. The encoding device of claim 11, wherein the processor is configured to indicate the priority level for the video frame using a priority identifier, and wherein the priority identifier includes a plurality of bits that indicates a different level of priority using a different bit sequence.

16. The encoding device of claim 11, wherein the processor is configured to indicate the priority level for the video frame in a video header or a signaling protocol.

17. The encoding device of claim 16, wherein the video frame is associated with a Network Abstraction Layer (NAL) unit, and wherein the video header is a NAL header.

18. The encoding device of claim 16, wherein the signaling protocol is indicated using a supplemental enhancement information (SEI) message, an MPEG media transport (MMT) protocol, or an access unit (AU) delimiter.

19. The encoding device of claim 11, wherein the processor is configured to determine the priority level of the video frame explicitly based on a number of referenced macro blocks or coding units in the video frame.

20. The encoding device of claim 11, wherein the processor is configured to determine the priority level of the video frame implicitly based on at least one of a reference picture set (RPS) or a reference picture list (RPL) size associated with the video frame.
